(19) United States
(12) Patent Application Publication
(10) Pub. No.: US 2025/0385535 A1
(43) Pub. Date: Dec. 18, 2025

(54) METHOD FOR CHARGING BATTERY

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Takeshi OSADA, Isehara, Kanagawa (JP); Yohei MOMMA, Isehara, Kanagawa (JP); Yasuhiro JINBO, Isehara, Kanagawa (JP); Ryota TAJIMA, Isehara, Kanagawa (JP)

(21) Appl. No.: 18/878,389

(22) PCT Filed: Jun. 28, 2023
(86) PCT No.: PCT/IB2023/056659

§ 371 Date: Dec. 23, 2024

(30) Foreign Application Priority Data
Jul. 8, 2022 (JP) 2022-110425

(51) Int. Cl. H02J 7/00; H01M 4/525; H01M 10/44

(52) U.S. Cl. CPC H02J 7/00712; H01M 4/525; H01M 10/44; H02J 7/0068

(57) ABSTRACT

To provide a charging method in accordance with a state of a positive electrode at the start of charging. To improve charge characteristics of a battery. The charging method is a method for charging a battery including a positive electrode active material represented by LiₓMO₂ in a positive electrode. The Mis one or more selected from Co, Ni, Mn, and Al. It is determined whether the first charging is necessary or not by a value of the x at a time when charging of the battery starts. In the case where the first charging is determined to be necessary, second charging and third charging are performed in order after the first charging is performed. In the case where the first charging is determined to be unnecessary, the second charging and the third charging are performed in order. The first charging is performed for a charge time longer than or equal to 10 seconds and shorter than or equal to 30 seconds with a current value that is higher than or equal to 1 C and lower than or equal to 5 C. The second charging is constant current charging, and the third charging is constant voltage charging.

### TECHNICAL FIELD

The invention disclosed in this specification and the like (hereinafter referred to as “the present invention” in this specification and the like in some cases) relates to a power storage device (also referred to as a battery, a secondary battery, a power storage module in some cases) and the like. In particular, the present invention relates to a lithium-ion battery. One embodiment of the present invention relates to a battery control circuit, a battery protection circuit, a power storage device, an electronic device, and operation methods thereof.

The present invention relates to an object, a method, or a manufacturing method. Alternatively, the present invention relates to a process, a machine, manufacture, or a composition (composition of matter). Alternatively, the present invention relates to a semiconductor device, a display device, a light-emitting device, a power storage device, a lighting device, an electronic device, a vehicle, or an operation method thereof.

### BACKGROUND ART

In recent years, a variety of power storage devices such as lithium-ion batteries, lithium ion capacitors, and air batteries have been actively developed. In particular, demands for lithium-ion batteries with high output and high energy density have rapidly grown with the development of the semiconductor industry, for portable information terminals such as mobile phones, smartphones, and laptop computers, portable music players, digital cameras, medical equipment, electric motor vehicles such as hybrid electric vehicles (HVs), electric vehicles (EVs), and plug-in hybrid electric vehicles (PHVs), and the like, and the lithium-ion batteries are essential as rechargeable energy supply sources for today's information society.

A lithium-ion battery varies in charge characteristics and discharge characteristics depending on the external environment of the battery or the internal state of the battery. For example, it is known that the charge capacity and the discharge capacity of a lithium-ion battery become small in a low-temperature environment, i.e., when the temperature of the battery is low. It is also known that lithium deposited on the negative electrode increases the risk of an internal short circuit, and deposited lithium fell off from the negative electrode leads to reduction of the amount of lithium that contributes to charging and discharging, for example. It is also known that the internal resistance of a battery is changed by a state (e.g., crystal structure) of an active material in the battery, which hinders rapid charging. As for active materials in batteries, lithium cobalt oxide and the like are known as positive electrode active materials (Non-Patent Document 1), graphite and the like are known as negative electrode active materials.

Thus, in the case where a power storage device is placed in a low-temperature environment, a power storage unit capable of heating a battery by pulse charging and discharging has been proposed (Patent Document 1). Moreover, as a countermeasure for lithium deposition, which is one of defects in rapid charging, a charging method in which a reverse pulse current flows in charging has been proposed (Patent Document 2).

### REFERENCE

### Patent Document

Patent Document 1 Japanese Published Patent Application No. 2002-125326
Patent Document 2 Japanese Published Patent Application No. 2014-187002

### Non-Patent Document

Non-Patent Document 1 G. G. Amatucci et. al., “CoO₂, The End Member of the LiₓCoO₂ Solid Solution”, J. Electrochem. Soc., 143 (3), 1114 (1996).

### SUMMARY OF THE INVENTION

### Problems to be Solved by the Invention

Patent Document 1 discloses a charging method in which the temperature of a battery is increased by Joule heat by repeating pulse discharging when a power storage device is placed in a low-temperature environment.

In Patent Document 2, a countermeasure for lithium deposition has been proposed, aiming at achieving rapid charging. Specifically, a charging method in which lithium deposited on a negative electrode is dissolved by flow of a reverse pulse current in charging is disclosed.

However, neither Patent Document 1 or Patent Document 2 discloses a charging method according to a state of an active material in a battery, specifically a state (crystal structure or the like) of a positive electrode active material included in a positive electrode.

In view of the above, an object of one embodiment of the present invention is to provide a charging method according to the state of a positive electrode as a charging method of a power storage device. Another object is to provide a charging method according to the state of a positive electrode active material. Another object is to provide a charging method according to a crystal structure of a positive electrode active material. An object of one embodiment of the present invention is to improve charge characteristics of a battery by providing such a charging method.

Note that the description of these objects does not preclude the presence of other objects. One embodiment of the present invention does not necessarily need to achieve all of these objects.

Other objects can be derived from the description of the specification, the drawings, and the claims.

### Means for Solving the Problems

One embodiment of the present invention is a charging method of a battery that differs depending on the state of a positive electrode at the start of charging.

One embodiment of the present invention is a method for charging a battery including a positive electrode active material represented by LiₓMO₂ in a positive electrode. The M is one or more selected from Co, Ni, Mn, and Al. Whether first charging is necessary or not is determined by a value of the x at a time when charging of the battery starts. In the case where the first charging is determined to be necessary, second charging and third charging are performed in order after the first charging is performed. In the case where the first charging is determined to be unnecessary, the second charging and the third charging are performed in order. The first charging is performed for a charge time longer than or equal to 10 seconds and shorter than or equal to 30 seconds with a current value that is higher than or equal to 1 C and lower than or equal to 5 C. The second charging is constant current charging, and the third charging is constant voltage charging.

In the above, in the case where the value of the x is within the range of 0.80 to 1.0, both inclusive, the first charging can be determined to be necessary.

Alternatively, in the above, in the case where the value of the x is within the range of 0.40 to 0.60, both inclusive, the first charging can be determined to be necessary.

Alternatively, in the above, in the case where the value of the x is within the range of 0.80 to 1.0, both inclusive, or within the range of 0.40 to 0.60, both inclusive, the first charging can be determined to be necessary.

In any one of the methods for charging the battery described above, whether first discharging is necessary or not is determined by the value of the x at a time when charging of the battery starts. In the case where the first discharging is determined to be necessary, the second charging and the third charging are performed in order after the first discharging is performed. In the case where the first discharging is determined to be unnecessary, the second charging and the third charging are performed in order, and the first discharging is performed for a discharge time longer than or equal to 10 seconds and shorter than or equal to 30 seconds with a current value that is higher than or equal to 1 C and lower than or equal to 5 C.

In the above method of charging the battery, in the case where the value of the x is within the range of 0.15 to 0.20, both inclusive, the first discharging is determined to be necessary.

### Effect of the Invention

According to one embodiment of the present invention, a charging method according to a state of a positive electrode active material can be provided. Alternatively, a charging method according to a state of a positive electrode active material can be provided. Alternatively, a charging method according to a crystal structure of a positive electrode active material can be provided. By providing such a charging method, the charge characteristics of a battery can be improved.

Note that the description of these effects does not preclude the presence of other effects. One embodiment of the present invention does not necessarily have all of these effects. Other effects can be derived from the description of the specification, the drawings, and the claims.

### BRIEF DESCRIPTION OF THE DRAWINGS

FIG. 1A is a graph showing a relation between x in LiₓCoO₂ and a c-axis length, and FIG. 1B is a diagram illustrating a crystal structure of LiCoO₂.

FIG. 2 is a diagram illustrating a method for charging a battery.

FIG. 3 is a flowchart illustrating a method for charging a battery.

FIG. 4A and FIG. 4B are diagrams each illustrating a method for charging a battery.

FIG. 5 is a diagram illustrating a method for charging a battery.

FIG. 6 is a flowchart illustrating a method for charging a battery.

FIG. 7 is a flowchart illustrating a method for charging a battery.

FIG. 8A to FIG. 8D are diagrams illustrating a structure example of a power storage device.

FIG. 9A is an exploded perspective view of a coin-type secondary battery, FIG. 9B is a perspective view of the coin-type secondary battery, and FIG. 9C is a cross-sectional perspective view thereof.

FIG. 10A illustrates an example of a cylindrical secondary battery. FIG. 10B illustrates an example of a cross-sectional structure of the cylindrical secondary battery. FIG. 10C illustrates an example of a plurality of cylindrical secondary batteries. FIG. 10D illustrates an example of a power storage system including the plurality of cylindrical secondary batteries.

FIG. 11A and FIG. 11B are diagrams illustrating examples of a secondary battery, and FIG. 11C is a diagram illustrating the internal state of the secondary battery.

FIG. 12A to FIG. 12C are diagrams illustrating an example of a secondary battery.

FIG. 13A and FIG. 13B are external views of a secondary battery.

FIG. 14A to FIG. 14C are diagrams illustrating a method for manufacturing a secondary battery.

FIG. 15A to FIG. 15C are diagrams illustrating structure examples of a battery pack.

FIG. 16A is a perspective view of a power storage module of one embodiment of the present invention, FIG. 16B is a block diagram of the power storage module, and FIG. 16C is a block diagram of a vehicle including the power storage module.

FIG. 17A to FIG. 17D are diagrams illustrating examples of transport vehicles. FIG. 17E is a diagram illustrating an example of an artificial satellite.

FIG. 18A and FIG. 18B are diagrams for describing a power storage device of one embodiment of the present invention.

FIG. 19A is a diagram illustrating an electric bicycle, FIG. 19B is a diagram illustrating a secondary battery of the electric bicycle, and FIG. 19C is a diagram illustrating a scooter.

FIG. 20A to FIG. 20D are diagrams illustrating examples of electronic devices.

FIG. 21A illustrates examples of wearable devices, FIG. 21B is a perspective view of a watch-type device, and FIG. 21C is a diagram illustrating a side surface of the watch-type device.

### Mode for Carrying Out the Invention

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments.

Note that in structures of the invention described below, the same portions or portions having similar functions are denoted by the same reference numerals in different drawings, and the description thereof is not repeated. The same hatching pattern is used for portions having similar functions, and the portions are not especially denoted by reference numerals in some cases.

The position, size, range, and the like of each component illustrated in drawings do not represent the actual position, size, range, and the like in some cases for easy understanding. Therefore, the disclosed invention is not necessarily limited to the position, size, range, and the like disclosed in drawings.

Furthermore, the embodiments and examples described below can be implemented by being combined with any of the embodiments, examples, and the like described in this specification and the like unless otherwise mentioned.

“Electronic devices” in this specification and the like mean all devices including power storage devices, and electro-optical devices including power storage devices, information terminal devices including power storage devices, and the like are all electronic devices.

In this specification and the like, a “power storage device” refers to an element having a function of storing power and all devices including the element having a function of storing power, and is also referred to as a power storage module. Examples of the power storage device include a battery (also referred to as a “secondary battery”) such as a lithium-ion battery, a lithium-ion capacitor, and an electric double layer capacitor.

In this specification and the like, a space group is represented using the short notation of the international notation (or the Hermann-Mauguin notation). In addition, the Miller indices are used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction that shows an orientation in a crystal is denoted by “[]”, a set direction that shows all of the equivalent orientations is denoted by “<>”, an individual plane that shows a crystal plane is denoted by “()”, and a set plane having equivalent symmetry is denoted by “{}”. A trigonal system represented by the space group R−3m is generally represented by a composite hexagonal lattice for easy understanding of the structure and is also represented by a composite hexagonal lattice in this specification and the like unless otherwise specified. In some cases, not only (hkl) but also (hkil) is used as the Miller indices. Here, i is −(h+k).

In addition, a given integer of 1 or more is represented by h, k, i, or l in some cases. Examples of (001) include (001), (003), and (006).

The space group of a crystal structure is identified by XRD, electron diffraction, neutron diffraction, or the like. Thus, in this specification and the like, the term “being attributed to a space group”, “belonging to a space group”, or “being a space group” can be rephrased as being identified as the space group.

In this specification and the like, the theoretical capacity of a positive electrode active material refers to the amount of electricity in the case where lithium that can be inserted and extracted in the positive electrode active material is all extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material can be represented by x (the occupancy rate of Li in lithium sites) in a compositional formula, e.g., LiₓCoO₂. In the case of a positive electrode active material included in a secondary battery, x=(theoretical capacity−charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2.

Note that in this specification and the like, ordinal numbers such as “first” and “second” are used for convenience and do not limit the number of components or the order of components (e.g., the order of steps or the stacking order of layers). An ordinal number used for a component in a certain part in this specification is not the same as an ordinal number used for the component in another part in this specification or claims in some cases.

In this specification and the like, the terms such as “electrode” and “wiring” do not limit the functions of the components. For example, an “electrode” is used as part of a “wiring” in some cases, and vice versa. Furthermore, the terms “electrode” and “wiring” also include the case where a plurality of “electrodes” and “wirings” are formed in an integrated manner, for example.

Functions of a “source” and a “drain” are sometimes switched when a transistor of opposite polarity is used or when the direction of a current is changed in circuit operation, for example. Therefore, the terms “source” and “drain” are interchangeable in this specification.

Note that in this specification and the like, the expression “electrically connected” includes the case where components are connected through “an object having any electric function”. Here, there is no particular limitation on the “object having any electric function” as long as electric signals can be transmitted and received between components that are connected through the object. Examples of the “object having any electric function” include a switching element such as a transistor, a resistor, an inductor, a capacitor, and other elements with a variety of functions as well as an electrode and a wiring.

### Embodiment 1

This embodiment will be described below.

One embodiment of the present invention is a power storage device capable of changing a charging method depending on the state of a positive electrode at the start of charging. The power storage device includes a battery, and the battery includes a positive electrode, a negative electrode, and an electrolyte. The positive electrode contains a positive electrode active material represented by LiₓMO₂, and M is one or more selected from Co, Ni, Mn, and Al. The positive electrode active material represented by LiₓMO₂ has a layered rock-salt crystal structure belonging to the space group R−3m.

One or more of lithium cobalt oxide, lithium cobalt-nickel oxide, lithium nickel-cobalt-manganese oxide, lithium nickel-cobalt-aluminum oxide, and lithium nickel-manganese-aluminum oxide can be used as the positive electrode active material represented by LiₓMO₂.

As the lithium cobalt oxide, for example, lithium cobalt oxide to which magnesium and fluorine are added can be used. It is preferable to use lithium cobalt oxide to which magnesium, fluorine, aluminum, and nickel are added.

As the lithium cobalt-nickel oxide, for example, lithium cobalt-nickel oxide to which magnesium and fluorine are added can be used. It is preferable to use lithium cobalt-nickel oxide to which magnesium, fluorine, and aluminum are added. Note that in lithium cobalt-nickel oxide, the number of cobalt atoms is larger than that of nickel atoms.

As the lithium nickel-cobalt-manganese oxide, for example, lithium nickel-cobalt-manganese oxide with nickel: cobalt: manganese=1:1:1, 6:2:2, 8:1:1, or 9:0.5:0.5 and the ratio in the neighborhood of the values as the ratio between the number of nickel atoms, the number of cobalt atoms, and the number of manganese atoms, can be used.

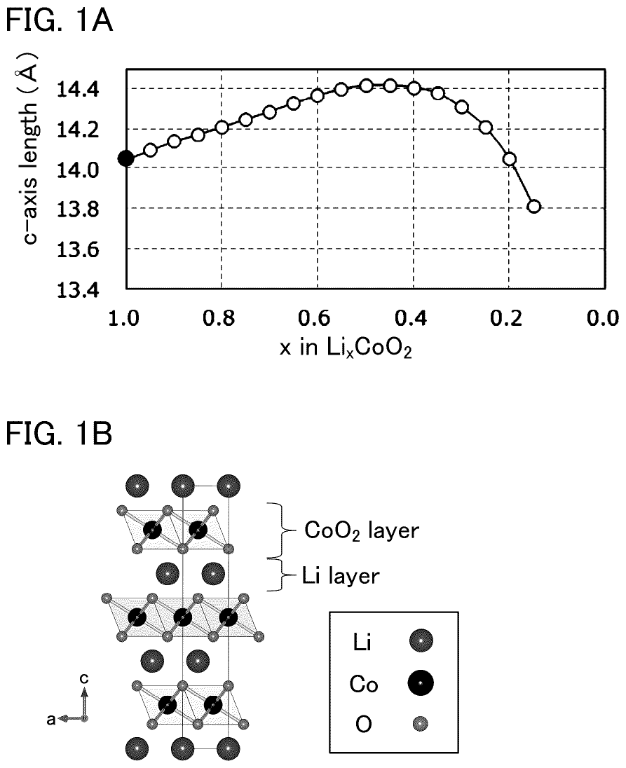

The crystal structure of a positive electrode active material represented by LiₓMO₂ changes when the amount of lithium contained in the positive electrode active material is changed by charging, discharging, or the like. FIG. 1A illustrates the proportion of lithium contained in lithium cobalt oxide (LiₓCoO₂), i.e., a relation between x and a c-axis length, as an example. Note that FIG. 1A is a graph drawn with reference to Non-Patent Document 1.

In FIG. 1A, LiCoO₂ is in a state where the value x on the horizontal axis of the graph is 1.0, and a positive electrode active material in a positive electrode of a battery can be regarded as being completely discharged (a black dot in the graph). When charging is performed, the value x on the horizontal axis becomes smaller than 1.0 (white circles in the graph). In other words, when the value of x on the horizontal axis of the graph is shifted rightward, charging is performed. Note that charging and discharging of the battery can be performed within the x range of 0.15 to 1.0, both inclusive.

As illustrated in FIG. 1A, in a positive electrode active material having a layered rock-salt crystal structure belonging to the space group R−3m, such as lithium cobalt oxide, the c-axis length has a tendency to become longer gradually from a completely discharged state (x=1.0) to x of approximately 0.5 and then to become shorter gradually by charging. As the charging further proceeds, the c-axis length becomes shorter than the c-axis length in the completely discharged state.

FIG. 1B is a diagram illustrating a crystal structure of lithium cobalt oxide having a layered rock-salt crystal structure belonging to the space group R−3m. In FIG. 1B, the CoO₂ layers and the Li layers are repeatedly arranged in the c-axis direction, and the CoO₂ layers and the Li layers are arranged parallel to the (001) plane. That is, a diffusion path of lithium ions is also parallel to the (001) plane, and an end portion of the Li layer serves as a portion where lithium ions enter and leaves. Thus, in the case where the c-axis length is long, lithium ions are more likely to be inserted and extracted than in the case where the c-axis length is short.

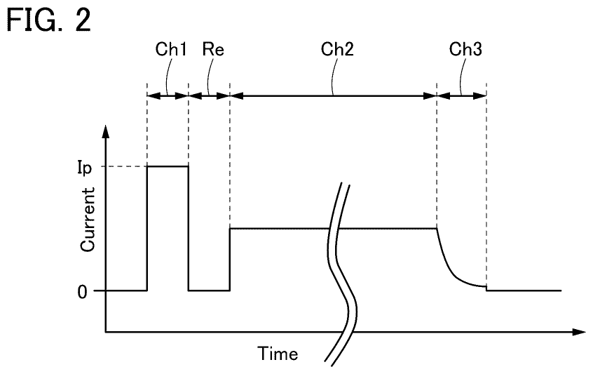

Thus, in the power storage device of one embodiment of the present invention, charging is performed by the charging method illustrated in FIG. 2 when a charge rate (SOC: State Of Charge) at the start of charging is low and the c-axis length of the positive electrode active material is short. A positive electrode active material with a low charge rate and a short c-axis length refers to, for example, in a positive electrode active material represented by LiₓMO₂, a state in which x is greater than or equal to 0.55 and less than or equal to 1.0, preferably greater than or equal to 0.70 and less than or equal to 1.0, further preferably greater than or equal to 0.80 and less than or equal to 1.0. When the state where the SOC=100% is set to x=0.15 is taken as an example, the state where the charge rate is low and the c-axis length is short means that the SOC is higher than or equal to 0% and lower than or equal to 53%, preferably higher than or equal to 0% and lower than or equal to 35%, further preferably higher than or equal to 0% and lower than or equal to 24%, for example.

Next, a charging method illustrated in FIG. 2 is described. FIG. 2 is a schematic view illustrating a charging method of a battery of one embodiment of the present invention, in which the vertical axis represents current and the horizontal axis represents time. In the charging in FIG.

2, first charging Ch1, a rest Re, second charging Ch2, and third charging Ch3 are performed in this order. The first charging Ch1 is performed with a higher current for a shorter time than the second charging Ch2 and the third charging Ch3 are. The second charging Ch2 is constant current charging, and the third charging Ch3 is constant voltage charging.

A preferable condition of the first charging Ch1 is a charge time of 10 seconds to 30 seconds, both inclusive, at a current value Ip of 1 C to 5 C, both inclusive, for example. The rest Re is a period during which charging and discharging are not performed, and in the case where the rest Re is long, the influence of the first charging Ch1 is reduced; thus, a period longer than 0 seconds and shorter than or equal to 30 seconds is preferable. Alternatively, it is acceptable not to perform the rest Re.

By performing the first charging Ch1, lithium ions are extracted from a region, serving as an exit, in which an end portion of the Li layer is exposed on the surface of the positive electrode active material. That is, the transient state is a state where the concentration of lithium ions in the vicinity of the region is lowered and the charge rate is high (a state where x is small). That is, according to the relation illustrated in FIG. 1A, the vicinity of the region is in a state with a long c-axis length, so that lithium ions can easily enter and leaves. Such a state enables later charging to be smoothly performed. In other words, the charge characteristics of the battery can be improved.

A condition of the second charging Ch2 can be a current value higher than or equal to 0.1 C and lower than or equal to 3 C, preferably higher than or equal to 0.5 C and lower than or equal to 2 C, for example. The second charging Ch2 stops when the voltage reaches a predetermined voltage. The predetermined voltage is the same as that of a constant voltage condition of the third charging Ch3 described later.

A condition of the second charging Ch2 can be a voltage higher than or equal to 4.0 V and lower than or equal to 4.7 V, for example. The third charging Ch3 is preferably stopped when the current value is lower than the predetermined current value. The predetermined current value can be approximately one-tenth that of the second charging Ch2, without limitations.

### Charging Flow 1 of Power Storage Device

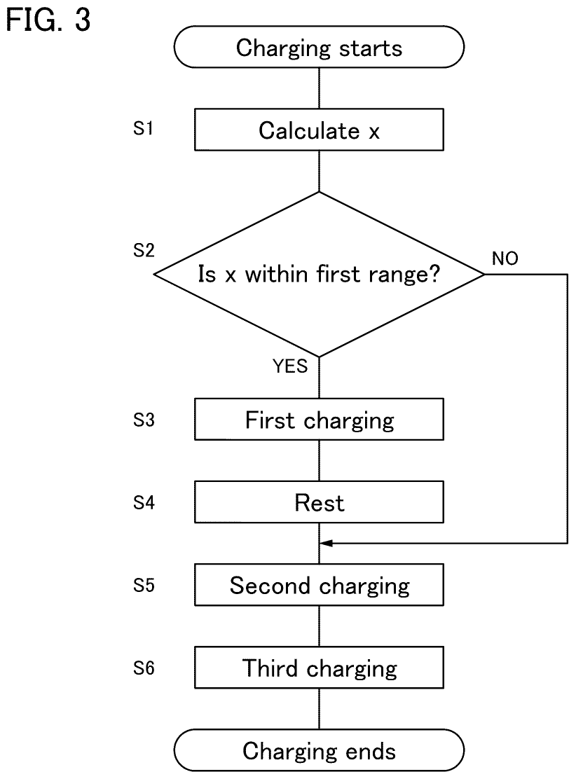

As for the above-described charging method, FIG. 3 is a flowchart illustrating a charging flow.

When charging of a battery is started, first, x in the positive electrode active material represented by LiₓMO₂ is calculated in Step S1. The x can be calculated from the charge rate of a battery; for example, x can be calculated on the basis of the value of the charge rate of the battery by a lookup table included in a charge control IC of a power storage device.

As a method for calculating the charge rate, there is a method of calculating from a lookup table included in a charge control IC of a power storage device on the basis of the value of an open circuit voltage of a battery. At this time, the value of x may be calculated from the lookup table included in the charge control IC of the power storage device on the basis of the value of the open circuit voltage of the battery. A current flowing through the battery may be measured with a coulomb counter, and the charge rate may be calculated on the basis of the accumulated amount of charge. Alternatively, a method may be employed in which the charge rate is calculated using a regression model based on data such as a voltage of a battery and a current flowing through the battery.

As a method for calculating x in the positive electrode active material represented by LiₓMO₂, after the internal resistance of the battery is measured, x can be calculated on the basis of the internal resistance value by using the lookup table included in the charge control IC of the power storage device.

Next, in Step S2, it is determined whether the first charging Ch1 is necessary or not. Specifically, whether the value of x calculated in Step S1 is within the first range is determined. The first range means the range of x in a state where the charge rate described above is low and the c-axis length is short. In the above example, x in the positive electrode active material represented by LiₓMO₂ is greater than or equal to 0.55 and less than or equal to 1.0, preferably greater than or equal to 0.70 and less than or equal to 1.0, further preferably greater than or equal to 0.80 and less than or equal to 1.0.

If x is within the first range (YES) in Step S2, the process proceeds to Step S3. Alternatively, if x is outside the first range (No) in Step S2, the process proceeds to Step S5.

When the process proceeds to Step S3, the first charging Ch1 starts. The conditions of the first charging Ch1 are similar to those described with reference to FIG. 2. After the first charging Ch1 ends, the process proceeds to Step S5 after the rest in Step S4. Alternatively, after the first charging Ch1 ends, the process may proceed to Step S5 without the rest in Step S4. The rest can be performed under conditions similar to those described with reference to FIG. 2.

In Step S5, the second charging Ch2 is performed. The conditions of the second charging Ch2 are similar to those described with reference to FIG. 2. When the voltage of the battery reaches a predetermined voltage by the second charging Ch2, the process proceeds to Step S6.

In Step S6, the third charging Ch3 is performed. The conditions of the third charging Ch3 are similar to those described with reference to FIG. 2. The second charging Ch2 in Step S5 and the third charging Ch3 in Step S6 are preferably performed successively.

When the third charging Ch3 in Step S6 ends, the charging flow illustrated in FIG. 3 ends.

With the charging flow illustrated in FIG. 3, charging can be performed by the charging method of the first charging Ch1 only when necessary, and thus efficient charging of the battery can be performed. The above is the description of the charging flowchart illustrated in FIG. 3.

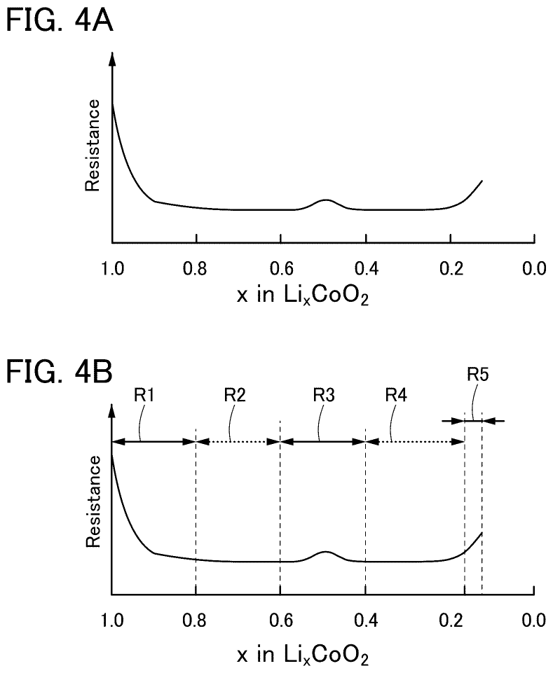

Next, the relation between the amount of lithium contained in lithium cobalt oxide (LiₓCoO₂) and a resistance is described with reference to FIG. 4A. The horizontal axis of FIG. 4A is the same as that of FIG. 1A, and the vertical axis of FIG. 4A represents the reaction resistance of lithium cobalt oxide. The lithium cobalt oxide illustrated as an example in FIG. 4A has a high reaction resistance when the range of x is around x=1.0. When the range of x is around x=0, the reaction resistance is high. When the range of x is around x=0.5, the reaction resistance is increased in some cases.

In the range of x showing a high reaction resistance, when x is around x=1.0, particularly, in the range of 0.8 to 1.0, both inclusive, it is inferred that the occupancy rate at lithium sites is high, lithium ions are less likely to move in a lithium cobalt oxide and thus the reaction resistance is high. When x is around x=0.2, i.e., x is closer to 0, it is inferred that the energy required for extracting lithium ions from lithium sites in the lithium cobalt oxide is increased and thus the reaction resistance is high. When x is around x=0.5, lithium ions are aligned in lithium sites in lithium cobalt oxide in some cases. The phrase “lithium ions are aligned” means that from a state where lithium ions are randomly extracted by charging, i.e., a state where lithium ions are left randomly, the lithium ions are regularly rearranged in lithium sites. That is, when x is around x =0.5, the reaction resistance is increased in some cases because of the influence of the alignment of lithium ions.

In the charging method of a power storage device of one embodiment of the present invention, charging including the first charging Ch1 described with reference to FIG. 2 enables subsequent charging to be smoothly performed. Thus, the first charging Ch1 is preferably performed in the range of x showing a high reaction resistance described with reference to FIG. 4A.

FIG. 4B is a diagram illustrating a first range R1, a second range R2, a third range R4, and a fifth range R5 that are added to FIG. 4A as the ranges of x. At this time, in the case where charging of the power storage device starts in the first range R1 and the third range R3, the first charging Ch1 is preferably performed.

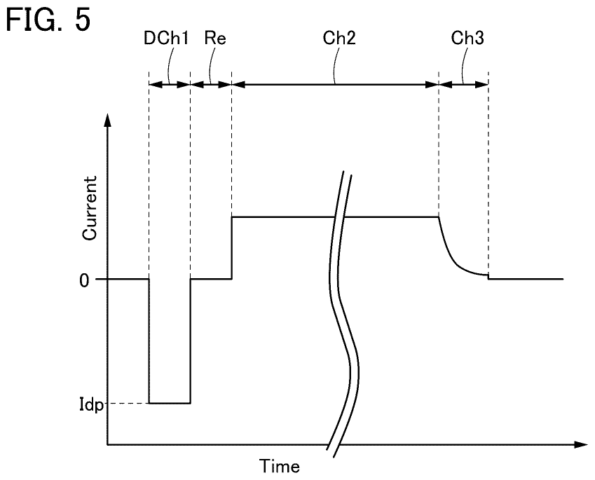

Referring to FIG. 1A, in the fifth range R5, the c-axis length of the positive electrode active material becomes longer by discharging the battery. That is, when the first charging Ch1 described with reference to FIG. 2 is performed, the c-axis length becomes short. Thus, in the case where charging is started in the fifth range R5, first discharging DCh1 is preferably performed as illustrated in FIG. 5. When the first discharging DCh1 is performed in the fifth range R5, the subsequent charging can proceed smoothly.

A charging method illustrated in FIG. 5 is described. FIG. 5 is a schematic view illustrating a charging method of a battery of one embodiment of the present invention, in which the vertical axis represents current and the horizontal axis represents time. Charging in FIG. 5 is performed in the order of the first discharging DCh1, the rest Re, the second charging Ch2, and the third charging Ch3. The first discharging DCh1 is charging performed with a higher current for a shorter time than the second charging Ch2 and the third charging Ch3. The second charging Ch2 is constant current charging, and the third charging Ch3 is constant voltage charging.

The discharge time is preferably longer than or equal to 10 seconds and shorter than or equal to 30 seconds with the current value Idp higher than or equal to 1C and lower than or equal to 5C as the condition of the first discharging DCh1, for example. The rest Re is a period during which charging and discharging are not performed, and in the case where the rest Re is long, the influence of the first discharging DCh1 is reduced; thus, a period longer than 0 seconds and shorter than or equal to 30 seconds is preferable for the rest Re. Furthermore, the period of the rest Re can be changed depending on the state of the battery. Alternatively, it is acceptable not to perform the rest Re.

The conditions of the second charging Ch2 and the third charging Ch3 illustrated in FIG. 5 can be similar to those described with reference to FIG. 2.

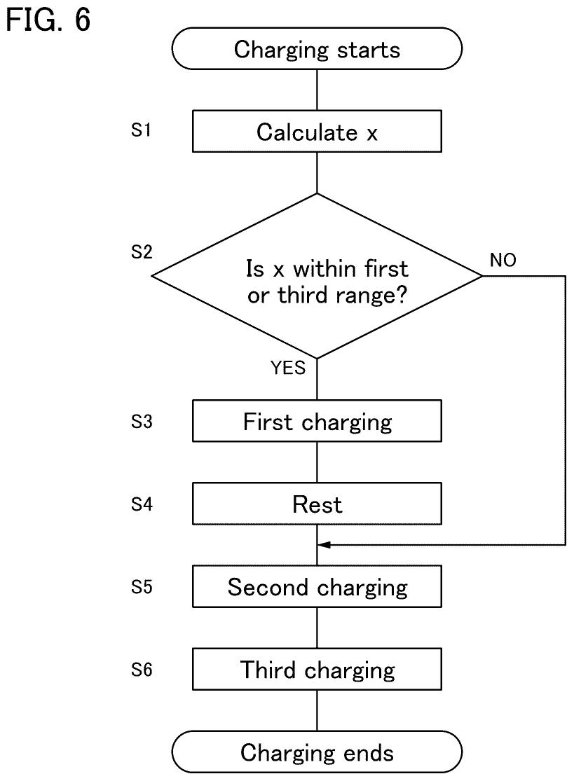

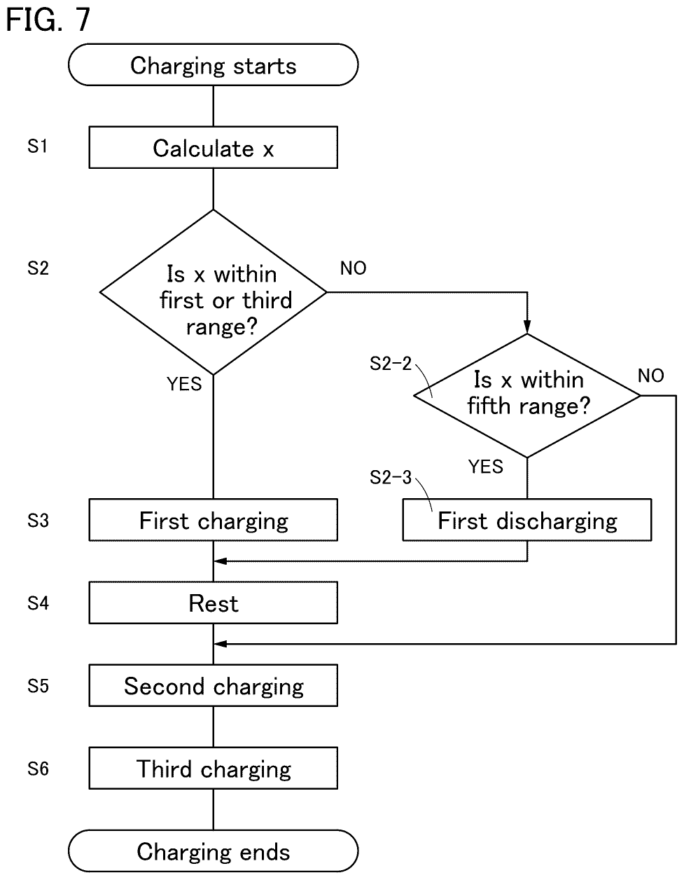

Note that in the case where charging of the power storage device is started in the second range R2 and the fourth range R4 in FIG. 4B, either the first charging Ch1 or the first discharging DCh1 is not performed and the second charging Ch2 and the third charging Ch3 can be performed. Examples of such a charging method are described with reference to FIG. 6 and FIG. 7.

Charging Flow 2 of Power Storage Device FIG. 6 is a flowchart illustrating an example of a charging method of a power storage device of one embodiment of the present invention. When charging of the power storage device is started, x in the positive electrode active material represented by LiₓMO₂ is calculated first in Step S1. The calculation method of x is preferably performed in a manner similar to that in Step S1 in FIG. 3.

Next, in Step S2, it is determined whether the first charging Ch1 is necessary or not. Specifically, whether the value of x calculated in Step S1 is within the first range R1 or the third range R3 is determined. The first range R1 refers to the range of x in a state where the charge rate is low and the c-axis length is short as described above. In other words, the first range R1 refers to a range where x in the positive electrode active material represented by LiₓMO₂ is greater than or equal to 0.80 and less than or equal to 1.0. The third range R3 refers to a range where x in the positive electrode active material represented by LiₓMO₂ is greater than or equal to 0.40 and less than or equal to 0.60. The second range R2 refers to a range where x is greater than 0.60 and less than 0.80.

If x is within the first range (YES) in Step S2, the process proceeds to Step S3. Alternatively, if x is outside the first range (No) in Step S2, the process proceeds to Step S5.

In the case where the process proceeds to Step S3, the first charging Ch1 starts. The conditions of the first charging Ch1 are similar to those described with reference to FIG. 2. After the first charging Ch1 ends, the process proceeds to Step S5 after the rest in Step S4. Alternatively, after the first charging Ch1 ends, the process may proceed to Step S5 without the rest in Step S4. The rest can be performed under conditions similar to those described with reference to FIG. 2.

In Step S5, the second charging Ch2 is performed. The conditions of the second charging Ch2 are similar to those described with reference to FIG. 2. When the voltage of the battery reaches a predetermined voltage by the second charging Ch2, the process proceeds to Step S6.

In Step S6, the third charging Ch3 is performed. The conditions of the third charging Ch3 are similar to those described with reference to FIG. 2. The second charging Ch2 in Step S5 and the third charging Ch3 in Step S6 are preferably performed successively.

When the third charging in Step S6 ends, the charging flow illustrated in FIG. 6 ends.

With the charging flow illustrated in FIG. 6, charging can be performed by the charging method of the first charging Ch1 only when necessary, and thus efficient charging of the battery can be performed.

### Charging Flow 3 of Power Storage Device

FIG. 7 is a flowchart illustrating an example of a charging method of a power storage device of one embodiment of the present invention. When charging of the power storage device is started, x in the positive electrode active material represented by LiₓMO₂ is calculated first in

Step S1. The calculation method of x is preferably performed in a manner similar to that in Step S1 in FIG. 3.

Next, in Step S2, it is determined whether the first charging Ch1 is necessary or not. Specifically, whether the value of x calculated in Step S1 is within the first range or the third range is determined. The first range refers to the range of x in a state where the charge rate is low and the c-axis length is short as described above. In other words, the first range R1 refers to a range where x in the positive electrode active material represented by LiₓMO₂ is greater than or equal to 0.80 and less than or equal to 1.0. The third range R3 refers to a range where x in the positive electrode active material represented by LiₓMO₂ is greater than or equal to 0.40 and less than or equal to 0.60. The second range R2 refers to a range where x is greater than 0.60 and less than 0.80.

If x is within the first range or the third range (YES) in Step S2, the process proceeds to Step S3. Alternatively, if x is outside the first range or the third range (No) in Step S2, the process proceeds to Step S2-2.

In the case where the process proceeds to Step S3, the first charging Ch1 starts. The conditions of the first charging Ch1 are similar to those described with reference to FIG. 2. After the first charging Ch1 ends, the process proceeds to Step S5 after the rest in Step S4. Alternatively, after the first charging Ch1 ends, the process may proceed to Step S5 without the rest in Step S4. The rest can be performed under conditions similar to those described with reference to FIG. 2.

In the case where the process proceeds to Step S2-2, it is determined whether the first discharging DCh1 is necessary or not. Specifically, whether the value of x calculated in Step S1 is within the fifth range is determined. The fifth range R5 refers to a range where x in the positive electrode active material represented by LiₓMO₂ is greater than or equal to 0.15 and less than or equal to 0.20. Note that the fourth range R2 refers to a range where x is greater than 0.20 and less than 0.40.

If x is within the fifth range (YES) in Step S2-2, the process proceeds to Step S2-3. Alternatively, if x is outside the fifth range (No) in Step S2-2, the process proceeds to Step S5.

In the case where the process proceeds to Step S2-3, the first discharging DCh1 starts. The conditions of the first discharging DCh1 are similar to those described with reference to FIG.

5. After the first discharging DCh1 ends, the process proceeds to Step S5 after the rest in Step S4. Alternatively, after the first discharging DCh1 ends, the process may proceed to Step S5 without the rest in Step S4.

In Step S5, the second charging Ch2 is performed. The conditions of the second charging Ch2 are similar to those described with reference to FIG. 2. When the voltage of the battery reaches a predetermined voltage by the second charging Ch2, the process proceeds to Step S6.

In Step S6, the third charging Ch3 is performed. The conditions of the third charging Ch3 are similar to those described with reference to FIG. 2. The second charging Ch2 in Step S5 and the third charging Ch3 in Step S6 are preferably performed successively. When the third charging Ch3 in Step S6 ends, the charging flow illustrated in FIG. 7 ends.

With the charging flow illustrated in FIG. 7, charging can be performed by the charging method of the first charging Ch1 or the first discharging DCh1 only when necessary, and thus efficient charging of the battery can be performed. The above is the description of the charging flow illustrated in FIG. 7.

### Power Storage Device

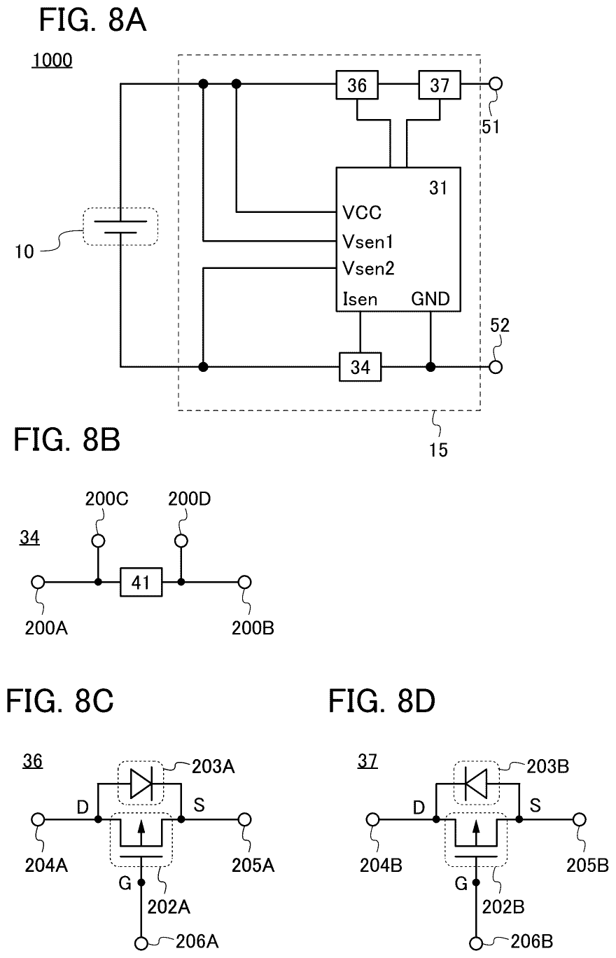

FIG. 8 is a diagram illustrating a structure example of a power storage device.

FIG. 8A is a circuit diagram illustrating an electrical connection between a battery 10, an IC (Integrated Circuit) 31, a current sensing element 34, an FET 36, an FET 37, an external terminal 51, and an external terminal 52 in a power storage device 1000.

The external terminal 51 is electrically connected to a positive electrode terminal of the battery 10, and the external terminal 52 is electrically connected to a negative electrode terminal of the battery 10. The external terminal 51 and the external terminal 52 of the power storage device 1000 are electrically connected to a power consumption portion included in an electronic device, a vehicle, or the like provided with the power storage device 1000. Note that the power consumption portion refers to a CPU, a memory, a display, or an inverter in an electronic device or refers to a motor, a light, power steering, or an inverter in a vehicle, for example.

In the power storage device 1000 illustrated in FIG. 8A, the positive electrode terminal of the battery 10 is electrically connected to a VCC terminal of the IC 31, and the negative electrode terminal of the battery 10 is electrically connected to a GND terminal of the IC 31.

The IC 31 has a function of sensing a current flowing through the battery 10 connected in series. In FIG. 8A, the current sensing element 34 is electrically connected to an Isen terminal of the IC 31. The current sensing element 34 is also referred to as a current sensor. The IC 31 also has a function of sensing the voltage of the battery 10. In FIG. 8A, Vsen1 of the IC 31 is electrically connected to the positive electrode terminal of the battery 10, and Vsen2 of the IC 31 is electrically connected to the negative electrode terminal of the battery 10.

As the current sensing element 34, a hall-type current sensor or a shunt-resistor-type sensor can be used. In the case where the hall-type current sensor is used as the current sensing element 34, a wiring electrically connecting the negative electrode terminal of the battery 10 and the external terminal 52 can be provided to pass through the inside of the current sensing element 34.

In the case where a shunt-resistor-type sensor is used as the current sensing element 34, the current sensing element 34 includes a resistor 41 (sometimes referred to as a shunt resistor) as illustrated in FIG. 8B, a terminal 200A of the resistor 41 included in the current sensing element 34 is electrically connected to the negative electrode terminal of the battery 10, and a terminal 200B is electrically connected to the external terminal 52. A terminal 200C and a terminal 200D of the resistor included in the current sensing element 34 are electrically connected to the Isen terminal and an Isen' terminal (not illustrated) of the IC 31, respectively. Note that in the structures illustrated in FIG. 8A and FIG. 8B, a wiring between the terminal 200D and the IC 31 may be omitted, and a wiring connected to the GND terminal of the IC 31 may be used for current sensing.

In this specification, a terminal refers to a portion for electrically connecting a battery, an IC, an FET element, or the like, and the shape of the terminal is not particularly limited. Any of terminals having various shapes such as a bolt shape, a wire shape, a flat plate shape, a ring shape, a socket shape, a pin shape, a solder hemispherical shape used for a BGA (Ball Grid Array), a flat plate shape used for an LGA (Land Grid Array), and a through-hole and a land (also referred to as a pad) of a PCB substrate can be used. Note that in a battery, part of the exterior body of the battery functions as a positive electrode terminal or a negative electrode terminal in some cases; in such a case, part of the exterior body of the battery can be used as a positive electrode terminal or a negative electrode terminal.

The IC 31 preferably has a function of protecting and a function of controlling the battery 10. The protection function can include, for example, one or more of overcharge protection, overdischarge protection, overcharge current protection, overdischarge current protection, and overheat protection of the battery. The control function can include one or more of charge control, discharge control, and cell balance control. That is, the IC 31 is preferably a battery control IC. Furthermore, the IC 31 is preferably a battery protection IC. Note that in the case where the IC 31 has a function of mainly controlling cell balance, the IC 31 can also be referred to as a cell balance control IC.

The IC 31 preferably has a function of a microcontroller. In the case where the IC 31 has a function of a microcontroller, the IC 31 includes a CPU, a memory, a clock generation circuit, an input portion, and an output portion. The input portion and the output portion are collectively referred to as an I/O portion in some cases. The IC 31 can operate in accordance with a program held in the memory. Furthermore, a lookup table of a relation between the open circuit voltage and the charge rate of the battery, a relation between the open circuit voltage and x of the battery, or the like can be stored in the memory.

FIG. 8C is a diagram illustrating the FET 36, and FIG. 8D is a diagram illustrating the FET 37.

As illustrated in FIG. 8C, the FET 36 includes a transistor 202A, a diode 203A, a terminal 204A, a terminal 205A, and a terminal 206A. The terminal 204A is electrically connected to the battery 10, the terminal 205A is electrically connected to the FET 37, and the terminal 206A is electrically connected to the IC 31. The terminal 204A is electrically connected to a drain (D) of the transistor 202A and an anode of the diode 203A. Note that a source and a drain of a transistor are sometimes interchangeable depending on the voltage applied therebetween; here, for easy understanding of a circuit structure, in a p-channel transistor, a terminal having a high potential in charging is called a source and the other terminal having a low potential in charging is called a drain. In an n-channel transistor, a terminal having a high potential is called a drain, and the other terminal having a low potential is called a source.

When the FET 36 has the structure illustrated in FIG. 8C, the FET 36 has a function of supplying a charge current of the battery 10, a function of blocking the charge current, and a function of supplying a discharge current of the battery 10.

As illustrated in FIG. 8D, the FET 37 includes a transistor 202B, a diode 203B, a terminal 204B, a terminal 205B, and a terminal 206B. The terminal 204B is electrically connected to the FET 36, the terminal 205B is electrically connected to the external terminal 51, and the terminal 206B is electrically connected to the IC 31. The terminal 204B is electrically connected to a drain (D) of the transistor 202B and a cathode of the diode 203B.

When the FET 37 has the structure illustrated in FIG. 8D, the FET 37 has a function of supplying a discharge current of the battery 10, a function of blocking the discharge current, and a function of supplying a charge current of the battery 10.

As described above, in the power storage device 1000 illustrated in FIG. 8A, the FET 36 has the function of supplying a charge current of the battery 10, the function of blocking the charge current, and the function of supplying a discharge current of the battery 10. The FET 37 has the function of supplying a discharge current of the battery 10, the function of blocking the discharge current, and the function of supplying a charge current of the battery 10.

Although FIG. 8A illustrates an example in which one FET 36 and one FET 37 are included in the power storage device 1000, one embodiment of the present invention is not limited to this structure. In the power storage device, two FETs 36 may be connected in parallel and two FETs 37 may be connected in parallel. With such a structure, high-current charging and discharging can be easily performed.

The circuit including the IC 31, the wirings for voltage sensing, the current sensing element 34, the FET 36, and the FET 37 described above is referred to as a control circuit 15 of the battery 10. That is, the control circuit 15 included in the power storage device 1000 illustrated in FIG. 8A includes a voltage sensor that senses voltage of the battery 10, a wiring for voltage detection, and a current sensor that senses current flowing through the battery 10. An IC other than the IC 31, for example, a cell balancing IC or a fuel gauge IC may be included in the control circuit 15.

The structure, method, and the like described in this embodiment can be used in an appropriate combination with any of structures, methods, and the like described in the other embodiments.

### Embodiment 2

This embodiment will describe components included in a lithium-ion battery, which is an example of a battery used as the battery 10. Although not described in this embodiment, a battery other than a lithium-ion battery, for example, a sodium-ion battery, a nickel-hydride battery, or a lead storage battery may be used as the battery 10.

The lithium-ion battery includes a negative electrode, a positive electrode, an electrolyte, a separator, and an exterior body.

### Negative Electrode

The negative electrode includes a negative electrode active material layer and a negative electrode current collector. The negative electrode active material layer includes a negative electrode active material and may further include a conductive material and a binder.

Metal foil can be used as the current collector, for example. The negative electrode can be formed by applying slurry onto the metal foil and drying the slurry. Note that pressing may be performed after drying. The negative electrode is a component obtained by forming an active material layer over the current collector.

Slurry refers to a material solution that is used to form the active material layer over the current collector and contains an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### Negative Electrode Active Material

As the negative electrode active material, for example, a carbon material or an alloy-based material can be used.

As the carbon material, for example, graphite (natural graphite and artificial graphite), graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can have a high operating voltage. In addition, graphite is preferable because of its advantages such as a relatively high capacity per unit volume, relatively small volume expansion, low cost, and a higher level of safety than that of lithium metal.

Non-graphitizing carbon can be obtained by baking a synthetic resin such as a phenol resin, and an organic substance of plant origin, for example. In non-graphitizing carbon contained in the negative electrode active material of the lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

As the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have a higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a compound containing the element, and the like are referred to as alloy-based materials in some cases.

In this specification and the like, “SiO” refers, for example, to silicon monoxide. SiO can alternatively be expressed as SiO_{y}. Here, it is preferable that y be 1 or have an approximate value of 1. For example, y is preferably greater than or equal to 0.2 and less than or equal to 1.5, further preferably greater than or equal to 0.3 and less than or equal to 1.2.

As the negative electrode active material, an oxide such as titanium dioxide (TiO₂), lithium titanium oxide (Li₄Ti₅O₁₂), a lithium-graphite intercalation compound (Li_{z}C₆), niobium pentoxide (Nb₂O₅), tungsten oxide (WO₂), or molybdenum oxide (MoO₂) can be used.

Alternatively, as the negative electrode active material, Li_{3-z}Me_{z}N (Me=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind of negative electrode active material among the negative electrode active materials shown above can be used; alternatively, a plurality of kinds can be used in combination. For example, a combination of a carbon material and silicon or a combination of a carbon material and silicon monoxide can be used.

As another mode of the negative electrode, a negative electrode that does not contain a negative electrode active material at the completion of the fabrication of the battery may be used. As the negative electrode that does not contain a negative electrode active material, for example, a negative electrode can be used in which only a negative electrode current collector is included at the completion of the fabrication of the battery and in which lithium ions extracted from the positive electrode active material due to charging of the battery are deposited as lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. As another film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case where the negative electrode that does not contain a negative electrode active material is used, a negative electrode current collector having projections and depressions can be used. In the case where the negative electrode current collector having projections and depressions is used, a depression of the negative electrode current collector becomes a cavity in which lithium contained in the negative electrode current collector is easily deposited, so that the lithium can be inhibited from having a dendrite-like shape when being deposited.

### Binder

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the fabrication of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group.

Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, the “passivation film” refers to a film without electrical conductivity or a film with extremely low electrical conductivity, and can inhibit the decomposition of the electrolyte solution at the battery reaction potentials in the case where the passivation film is formed on the active material surface, for example. It is further desirable that the passivation film can conduct lithium ions while inhibiting electrical conduction.

### Conductive Material

The conductive material is also referred to as a conductivity-imparting agent or a conductive additive, and a carbon material is used as the conductive material. The conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Active material layers such as the positive electrode active material layer and the negative electrode active material layer preferably contain a conductive material.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be fabricated by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like carbon nanofiber.

The active material layer may contain, as a conductive material, metal powder or metal fiber of copper, nickel, aluminum, silver, gold, or the like, a conductive ceramic material, or the like.

The content of the conductive material to the total volume of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-containing compound such as carbon black or graphite and a fibrous carbon-containing compound such as carbon nanotube easily enter a microscopic space. A microscopic space means, for example, a region or the like between a plurality of active materials.

When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the fabrication method of one embodiment of the present invention can have high capacity density per volume and stability, and is effective as an in-vehicle battery.

### Current Collector

As the current collector, a highly conductive material which does not alloy with a carrier ion of lithium or the like, for example, a metal such as stainless steel, gold, platinum, zinc, iron, copper, aluminum, or titanium, or an alloy thereof can be used. The current collector can have a sheet-like shape, a net-like shape, a punching-metal shape, an expanded-metal shape, or the like as appropriate.

A resin current collector can be used as the current collector. As the resin current collector, for example, a resin current collector including a resin such as polyolefin (e.g., polypropylene or polyethylene), nylon (polyamide), polyimide, vinylon, polyester, acrylic, or polyurethane, and a particulate or fibrous conductive material (also referred to as a conductive filler) can be used.

As the conductive material contained in the resin current collector, a conductive carbon material and one or more of metal materials such as aluminum, titanium, stainless steel, gold, platinum, zinc, iron, and copper can be used. For example, one kind or two or more kinds of carbon black such as acetylene black or furnace black, graphite such as artificial graphite or natural graphite, carbon fiber such as carbon nanofiber or carbon nanotube, graphene, and a graphene compound can be used as the conductive carbon material. Note that in the case where the resin current collector is used as a positive electrode current collector, an antioxidant such as a hindered phenol-based material is further preferably used.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be fabricated by, for example, a vapor deposition method.

Note that the average particle diameter of the conductive material contained in the resin current collector can be greater than or equal to 10 nm and less than or equal to 10 μm, and is preferably greater than or equal to 30 nm and less than or equal to 5 μm.

The current collector preferably has a thickness greater than or equal to 5 μm and less than or equal to 30 μm.

Note that a material that does not alloy with carrier ions of lithium or the like is preferably used for the negative electrode current collector.

### Positive Electrode

A positive electrode includes a positive electrode active material layer and a positive electrode current collector. The positive electrode active material layer includes a positive electrode active material and may further include at least one of a conductive material and a binder. Note that the positive electrode current collector, the conductive material, and the binder described in [Negative electrode] can be used.

Metal foil can be used as the current collector, for example. The positive electrode can be formed by applying slurry onto the metal foil and drying the slurry. Note that pressing may be performed after drying. The positive electrode is a component obtained by forming an active material layer over the current collector.

Slurry refers to a material solution that is used to form the active material layer over the current collector and contains an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

As the positive electrode active material, the positive electrode active material described in Embodiment 1 can be used.

### Electrolyte

Examples of the electrolyte are described below. As one mode of the electrolyte, a liquid electrolyte (also referred to as an electrolyte solution) containing a solvent and an electrolyte dissolved in the solvent can be used. The electrolyte is not limited to a liquid electrolyte (electrolyte solution) that is liquid at room temperature, and a solid electrolyte can be used as well. Alternatively, an electrolyte including both a liquid electrolyte that is liquid at room temperature and a solid electrolyte that is a solid at room temperature (such an electrolyte is referred to as a semi-solid electrolyte) can also be used. Note that when the solid electrolyte or the semi-solid electrolyte is used for a bendable battery, employing a structure where part of a stack in the battery includes the electrolyte can maintain the flexibility of the battery.

In the case where a liquid electrolyte is used for a secondary battery, one of ethylene carbonate (EC), propylene carbonate (PC), butylene carbonate, chloroethylene carbonate, vinylene carbonate, y-butyrolactone, y-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds thereof can be used in an appropriate combination at an appropriate ratio, for example.

Alternatively, the use of one or more of ionic liquids (normal temperature molten salts) which have features of non-flammability and non-volatility as a solvent of an electrolyte can prevent a secondary battery from exploding or catching fire even when an internal region of a secondary battery shorts out or the temperature in the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LIN(C₂F₅SO₂)₂, or the like can be used, for example.

For example, an organic solvent described in this embodiment contains ethylene carbonate (EC), ethyl methyl carbonate (EMC), and dimethyl carbonate (DMC). When the total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is m:n:100−m−n (where 5≤m≤35 and 0<n<65) can be used. More specifically, an organic solvent containing EC, EMC, and DMC at EC:EMC:DMC=30:35:35 (volume ratio) can be used.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis (oxalate) borate (LiBOB), or a dinitrile compound such as succinonitrile or adiponitrile may be added to the electrolyte solution. The concentration of the additive agent in the solvent is, for example, higher than or equal to 0.1 wt % and lower than or equal to 5 wt %.

When a high-molecular material that is gelable is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; or the like can be used. For example, PVDF-HFP, which is a copolymer of PVDF and hexafluoropropylene (HFP), can be used. The formed polymer may be porous.

### Separator

When the electrolyte includes an electrolyte solution, a separator is placed between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably processed into a pouch-like shape to wrap one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, degradation of the separator during high-voltage charging can be inhibited and thus the reliability of the secondary battery can be improved. When the separator is coated with the fluorine-based material, the separator is easily brought into close contact with an electrode, resulting in high output characteristics. When the separator is coated with the polyamide-based material, specifically, aramid, heat resistance can be improved to increase the safety of the secondary battery.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### Exterior Body

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The structure, method, and the like described in this embodiment can be used in an appropriate combination with structures, methods, and the like described in the other embodiments.

### Embodiment 3

In this embodiment, examples of the shape of the battery 10 will be described.

### Coin-Type Secondary Battery

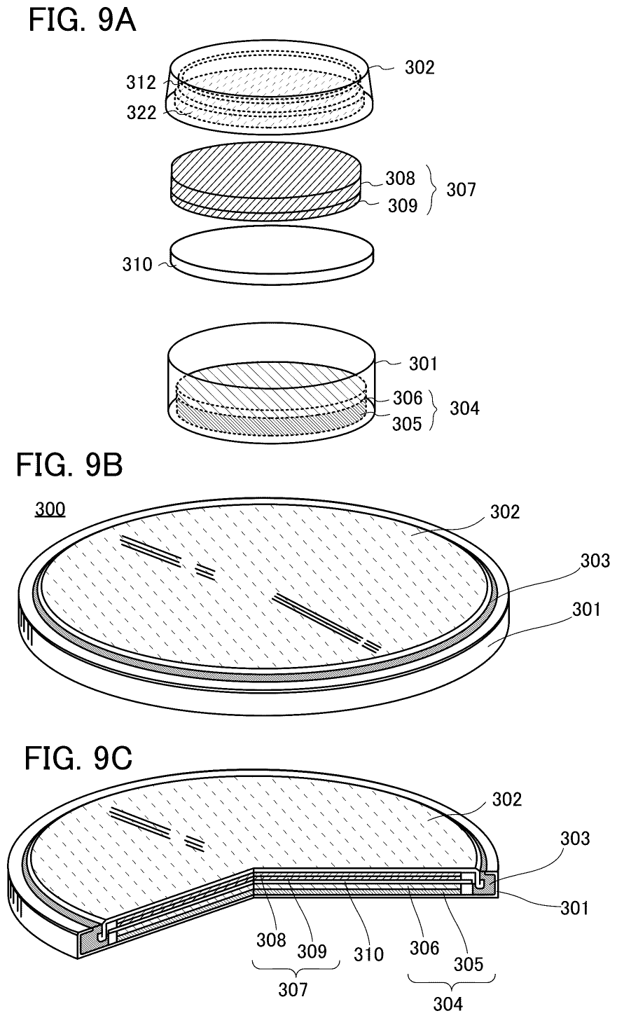

An example of a coin-type secondary battery is described here. FIG. 9A is an exploded perspective view of a coin-type (single-layer flat type) secondary battery, FIG. 9B is an external perspective view thereof, and FIG. 9C is a cross-sectional perspective view thereof. Coin-type secondary batteries are mainly used in small electronic devices.

Note that, for easy understanding, FIG. 9A is a schematic view illustrating overlap (a vertical relation and a positional relation) between components. Thus, FIG. 9A and FIG. 9B do not completely correspond with each other.

In FIG. 9A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 9A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 9B is an external perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 9C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated. In the coin-type secondary battery 300, the positive electrode can 301 and the negative electrode can 302 can be referred to as a positive electrode terminal and a negative electrode terminal, respectively.

With the above-described structure, the coin-type secondary battery 300 can have high discharge capacity and excellent cycle performance.

### Cylindrical Secondary Battery

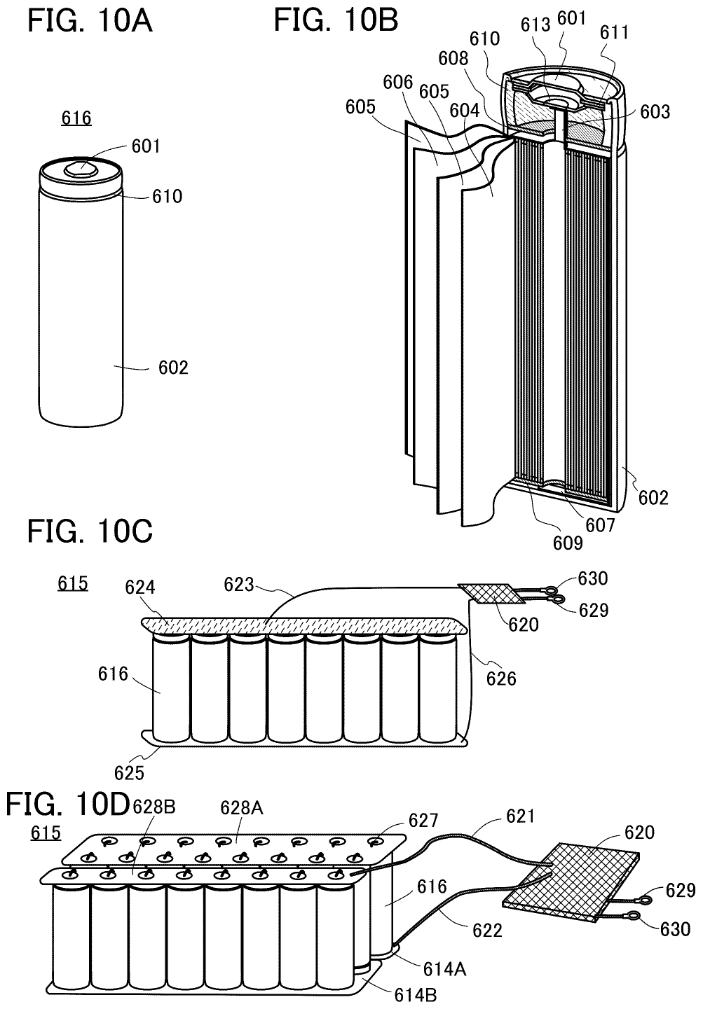

An example of a cylindrical secondary battery is described with reference to FIG. 10A. As illustrated in FIG. 10A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610. In the cylindrical secondary battery 616, the positive electrode cap 601 and the battery can 602 can be referred to as a positive electrode terminal and a negative electrode terminal, respectively.

FIG. 10B schematically illustrates a cross section of the cylindrical secondary battery. The cylindrical secondary battery illustrated in FIG. 10B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a separator 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a set of an insulating plate 608 and an insulating plate 609 that face each other. The inside of the battery can 602 provided with the battery element is filled with a nonaqueous electrolyte solution (not illustrated). As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 10C illustrates an example of a power storage module 615. The power storage module 615 includes a plurality of secondary batteries 616. Positive electrodes of the secondary batteries are in contact with and electrically connected to a conductor 624. Negative electrodes of the secondary batteries are in contact with and electrically connected to a conductor 625. Thus, the conductor 624 can be referred to as a positive electrode terminal of a power storage device (an assembled battery), and the conductor 625 can be referred to as a negative electrode terminal of the power storage device (the assembled battery). The conductor 624 is electrically connected to a control circuit 620 through a wiring 623. The conductor 625 is electrically connected to the control circuit 620 through a wiring 626. As the control circuit 620, a charging and discharging control circuit for performing charging, discharging, and the like or a protection circuit for preventing overcharging and/or overdischarging can be used. The control circuit 620 includes an external terminal 629 and an external terminal 630.

FIG. 10D illustrates an example of the power storage module 615. The power storage module 615 includes the plurality of secondary batteries 616, and the plurality of secondary batteries 616 are sandwiched between a conductive plate 628 (a conductive plate 628A and a conductive plate 628B) and a conductive plate 614 (a conductive plate 614A and a conductive plate 614B). The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage module 615 including the plurality of secondary batteries 616, high electric power can be obtained. Note that the plurality of secondary batteries 616 can be referred to as a power storage device or an assembled battery. In this case, a conductive plate having the highest potential between the conductive plate 628 and the conductive plate 614 can be referred to as a positive electrode terminal of the power storage device or a positive electrode terminal of the assembled battery. A conductive plate having the lowest potential between the conductive plate 628 and the conductive plate 614 can be referred to as a negative electrode terminal of the power storage device or a negative electrode terminal of the assembled battery.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage module 615 is less likely to be influenced by the outside temperature.

In FIG. 10D, the power storage module 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614. The control circuit 620 includes an external terminal 629 and an external terminal 630.

### Other Structure Examples of Secondary Battery

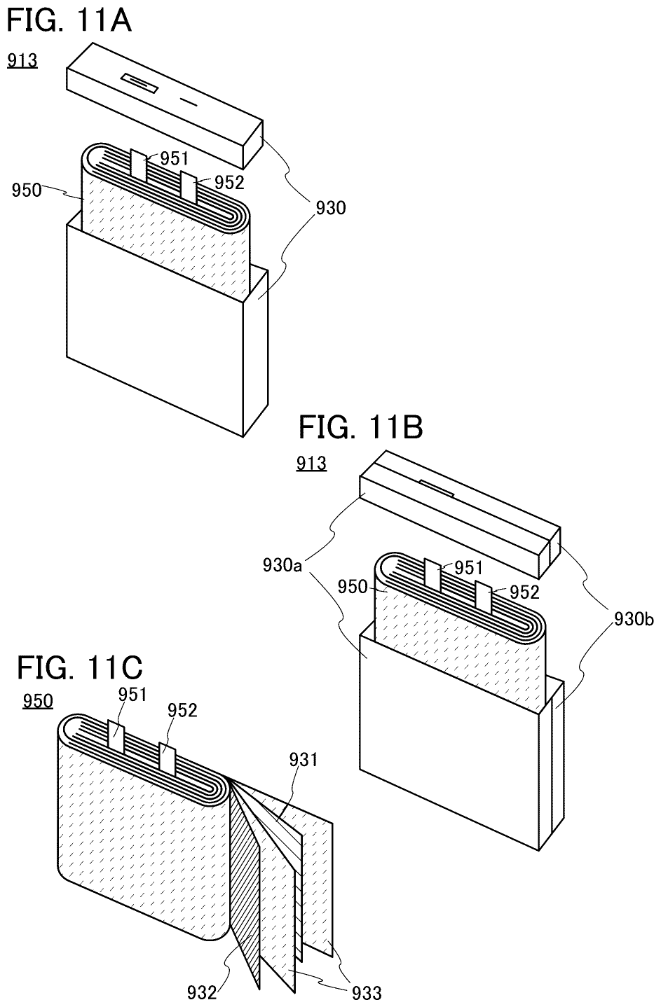

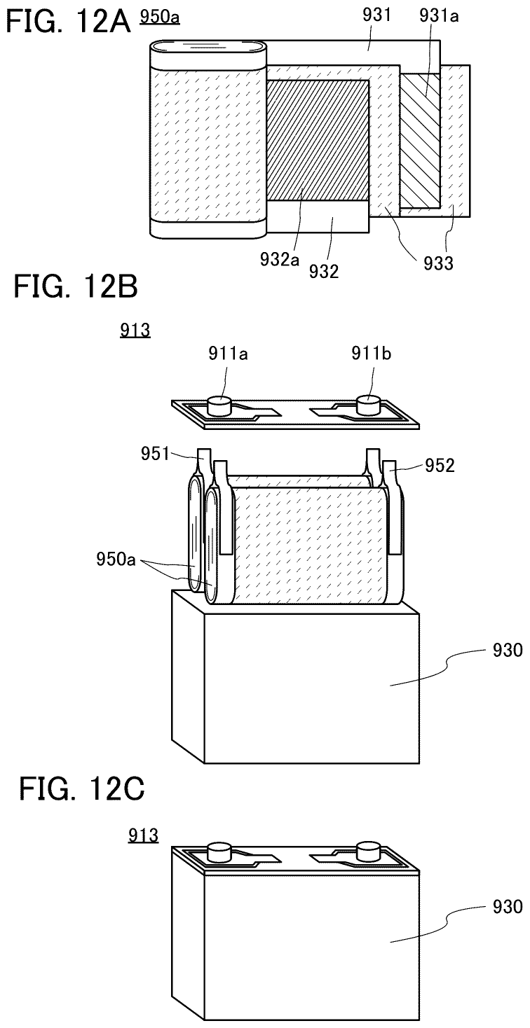

Structure examples of secondary batteries are described with reference to FIG. 11 and FIG. 12.

A secondary battery 913 illustrated in FIG. 11A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 11A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 11B, the housing 930 illustrated in FIG. 11A may be formed using a plurality of materials. For example, in the secondary battery 913 illustrated in FIG. 11B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 11C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 12, the secondary battery 913 may include a wound body 950a. The wound body 950a illustrated in FIG. 12A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 12B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 12C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, the safety valve is a valve to be released when the internal pressure of the housing 930 reaches a predetermined pressure.

As illustrated in FIG. 12B, the secondary battery 913 may include a plurality of the wound bodies 950a. The use of the plurality of wound bodies 950a enables the secondary battery 913 to have higher discharge capacity. The description of the secondary battery 913 illustrated in FIG. 11A to FIG. 11C can be referred to for the other components of the secondary battery 913 illustrated in FIG. 12A and FIG. 12B.

### Laminated Secondary Battery

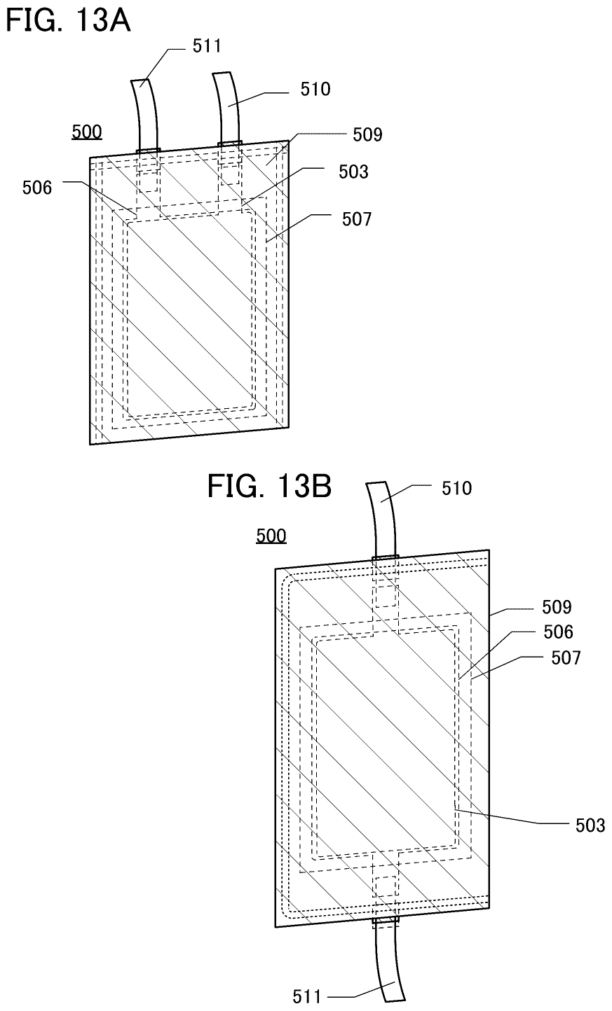

Next, examples of the appearance of a laminated secondary battery are illustrated in FIG. 13A and FIG. 13B. In FIG. 13A and FIG. 13B, a positive electrode 503, a negative electrode 506, a separator 507, an exterior body 509, a positive electrode lead electrode 510, and a negative electrode lead electrode 511 are included. A portion of the positive electrode lead electrode 510 that is exposed to the outside of the secondary battery can be referred to as a positive electrode terminal, and a portion of the negative electrode lead electrode 511 that is exposed to the outside of the secondary battery can be referred to as a negative electrode terminal.

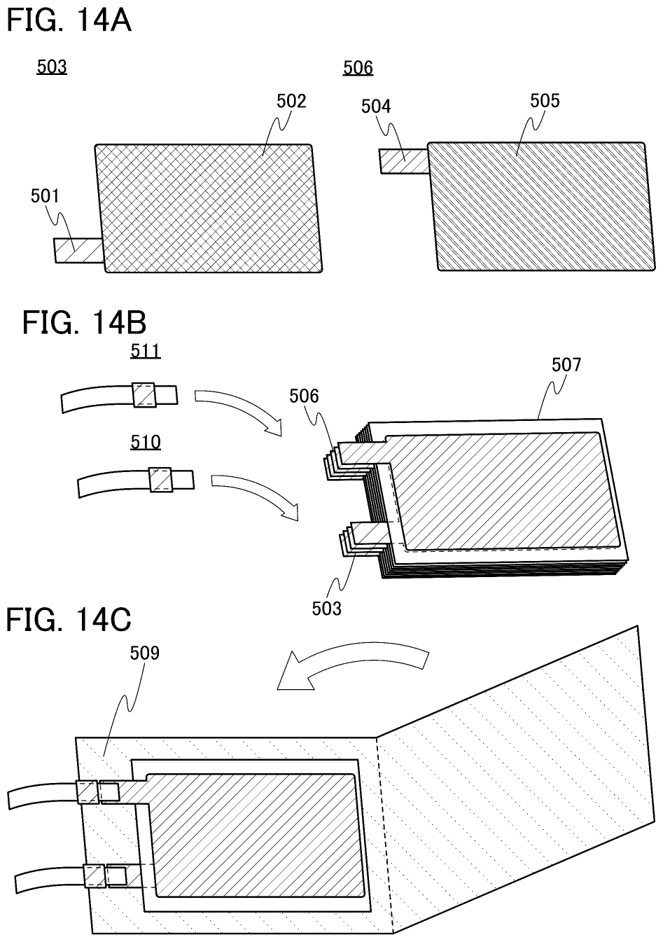

FIG. 14A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples illustrated in FIG. 14A.

### Method for Fabricating Laminated Secondary Battery

An example of a method for fabricating a laminated secondary battery whose external view is illustrated in FIG. 13A will be described with reference to FIG. 14B and FIG. 14C.

First, the negative electrode 506, the separator 507, and the positive electrode 503 are stacked. FIG. 14B illustrates the negative electrodes 506, the separators 507, and the positive electrodes 503 that are stacked. Here, an example in which five negative electrodes and four positive electrodes are used is illustrated. The example illustrated in FIG. 14B can also be referred to as a stack including the negative electrodes, the separators, and the positive electrodes.

Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, as illustrated in FIG. 14C, the negative electrodes 506, the separators 507, and the positive electrodes 503 are placed over the exterior body 509.

Subsequently, the exterior body 509 is folded along a portion indicated by a dashed line, as illustrated in FIG. 14C. Then, the outer edges of the exterior body 509 are bonded to each other. The bonding is performed by thermocompression bonding, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is bonded. In this manner, the laminated secondary battery 500 can be fabricated.

### Examples of Battery Pack

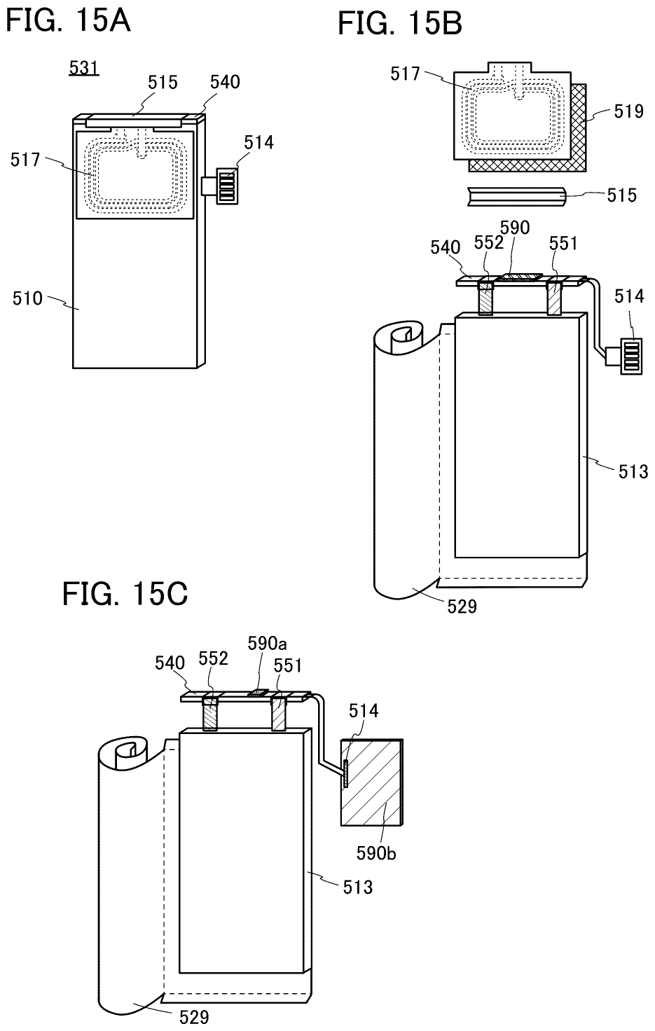

Examples of a secondary battery pack of one embodiment of the present invention that is capable of wireless charging using an antenna will be described with reference to FIG. 15.

FIG. 15A is a diagram illustrating the appearance of a secondary battery pack 531 that has a rectangular solid shape with a small thickness (also referred to as a flat plate shape with a certain thickness). FIG. 15B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

The secondary battery pack 531 includes a control circuit 590 over the circuit board 540 as illustrated in FIG. 15B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead. Note that in some cases, the positive electrode lead is referred to as a positive electrode terminal and the negative electrode lead is referred to as a negative electrode terminal.

In the secondary battery pack 531, the structure of the power storage device 1000 or the like described in Embodiment 1 can be used for the structures of the secondary battery 513 and the control circuit 590.

Alternatively, as illustrated in FIG. 15C, a circuit system 590a provided over the circuit board 540 and a circuit system 590b electrically connected to the circuit board 540 through the terminal 514 may be included. Note that the terminal 514 includes a plurality of terminals that includes at least a high potential terminal (the external terminal 51 in FIG. 1B) and a low potential terminal (the external terminal 52 in FIG. 1B).

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The structure, method, and the like described in this embodiment can be used in an appropriate combination with any of the structures, methods, and the like described in the other embodiments.

### Embodiment 4

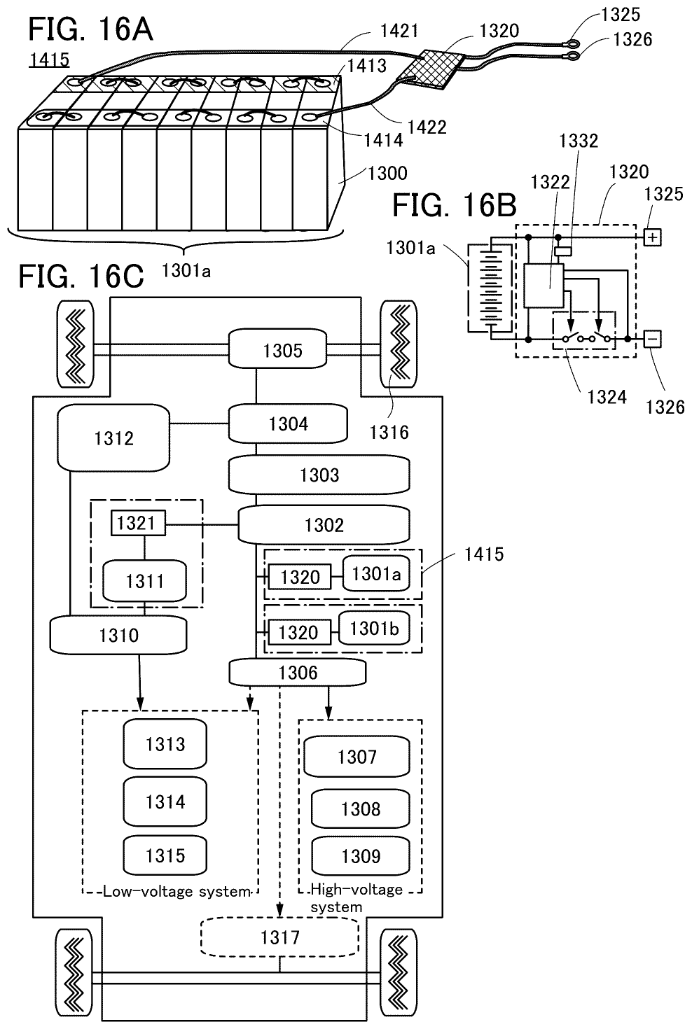

In this embodiment, examples of vehicles each including the secondary battery of one embodiment of the present invention will be described with reference to FIG. 16. The structure of the power storage device 1000 or the like described in Embodiment 1 can be used for the secondary battery and the control circuit described in this embodiment.

The secondary battery can be used in vehicles, typically automobiles. Examples of the automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. The vehicles are not limited to automobiles. Examples of the vehicles include a train, a monorail train, a ship, a submarine (a deep-submergence vehicle and an unmanned submarine), a flying object (a helicopter, an unmanned aircraft (a drone), an airplane, a rocket, and an artificial satellite), an electric bicycle, and an electric motorcycle, and the secondary battery of one embodiment of the present invention can be used for the vehicles.

As illustrated in FIG. 16C, the electric vehicle is provided with first power storage devices 1301a and 1301b as main secondary batteries for driving and a second power storage device 1311 that supplies electric power to an inverter 1312 for starting a motor 1304. The second power storage device 1311 is also referred to as a cranking battery (also referred to as a starter battery). The second power storage device 1311 only needs high output and high capacity is not so much needed; the capacity of the second power storage device 1311 is lower than that of the first power storage devices 1301a and 1301b.

The internal structure of the first power storage device 1301a may be the wound structure illustrated in FIG. 11C or FIG. 12A or the stacked-layer structure illustrated in FIG. 13A or FIG. 13B. Alternatively, an all-solid-state battery may be used as the first power storage device 1301a. The use of the all-solid-state battery as the first power storage device 1301a can achieve high capacity, improvement in safety, and reduction in size and weight.

Although this embodiment describes an example in which the two first power storage devices 1301a and 1301b are connected in parallel, three or more power storage devices may be connected in parallel. In the case where the first power storage device 1301a can store sufficient electric power, the first power storage device 1301b may be omitted. By using a battery pack including a plurality of secondary batteries in the power storage device, high electric power can be obtained. The plurality of secondary batteries may be connected in parallel, connected in series, or connected in series after being connected in parallel. The plurality of secondary batteries are also referred to as an assembled battery.

In order to cut off electric power from the plurality of secondary batteries in the vehicle, a service plug or a circuit breaker that can cut off a high voltage without the use of equipment is included in the first power storage device 1301a.

Electric power from the first power storage devices 1301a and 1301b is mainly used to rotate the motor 1304 and is supplied to in-vehicle parts for 42 V (such as an electric power steering 1307, a heater 1308, and a defogger 1309) through a DCDC converter 1306. Even in the case where a rear motor 1317 is provided for rear wheels, the first power storage device 1301a is used to rotate the rear motor 1317.

The second power storage device 1311 supplies electric power to in-vehicle parts for 14 V (such as a stereo 1313, a power window 1314, and lamps 1315) through a DCDC circuit 1310.

Next, the first power storage device 1301a is described with reference to FIG. 16A.

FIG. 16A illustrates an example in which nine rectangular secondary batteries 1300 form one power storage module 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing).

Since a vibration or a jolt is assumed to be given to the vehicle from the outside (e.g., a road surface), the plurality of secondary batteries are preferably fixed by the fixing portion 1413 or 1414, a battery container box, or the like. Furthermore, the one electrode is electrically connected to a control circuit portion 1320 through a wiring 1421. Furthermore, the other electrode is electrically connected to the control circuit portion 1320 through a wiring 1422. In the first power storage device 1301a, between the electrodes connected to the wiring 1421 and the electrodes connected to the wiring 1422, the electrodes with high potentials can be referred to as a positive electrode terminal of the first power storage device 1301a, and the electrodes with low potentials can be referred to as a negative electrode terminal of the first power storage device 1301a. The control circuit portion 1320 includes an external connection terminal 1325 and an external connection terminal 1326.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In—M—Zn oxide (an element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In—M—Zn oxide that can be used as the metal oxide is preferably a CAAC-OS (C-Axis Aligned Crystal Oxide Semiconductor) or a CAC-OS (Cloud-Aligned Composite Oxide Semiconductor). Alternatively, an In-Ga oxide or an In-Zn oxide may be used as the metal oxide. The CAAC-OS is an oxide semiconductor that has a plurality of crystal regions having c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, a high on-state current (Iₒₙ), a high field-effect mobility (μ), and favorable switching operation can be achieved.

Oxide semiconductors have various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety.

The control circuit portion 1320 that includes a memory circuit including a transistor using an oxide semiconductor can also function as an automatic control device for the secondary battery to eliminate causes of instability, such as a micro-short circuit. Examples of functions of eliminating causes of instability such as a micro-short circuit include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, detection of abnormal behavior due to a micro-short circuit, and anomaly prediction regarding a micro-short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, there is a risk that the abnormal voltage value may adversely affect estimation to be performed subsequently.

One of the causes of a micro-short circuit is as follows: it is thought that charging and discharging performed multiple times or uneven distribution of a positive electrode active material causes local concentration of current in part of the positive electrode and part of the negative electrode, whereby part of a separator stops functioning or a by-product is generated by a side reaction to generate a micro short-circuit.

It can be said that the control circuit portion 1320 not only senses a micro-short circuit but also senses a terminal voltage of the secondary battery and controls the charge and discharge state of the secondary battery. For example, to prevent overcharging, an output transistor of a charge circuit and an interruption switch can be turned off substantially at the same time.

Next, FIG. 16B illustrates an example of a block diagram of the power storage module 1415 illustrated in FIG. 16A.

The control circuit portion 1320 includes a switch portion 1324 that includes at least a switch for preventing overcharging and a switch for preventing overdischarging, a control circuit 1322 for controlling the switch portion 1324, a portion for measuring the voltage of the first power storage device 1301a, and a PTC element 1332. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 senses a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes the external connection terminal 1325 (+IN) and the external connection terminal 1326 (−IN).

The switch portion 1324 can be formed with a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOz (gallium oxide, where z is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first power storage devices 1301a and 1301b mainly supply electric power to in-vehicle parts for 42 V (high-voltage system), and the second power storage device 1311 supplies electric power to in-vehicle parts for 14 V (low-voltage system). Lead storage batteries are usually used for the second power storage device 1311 due to cost advantage. Lead storage batteries have disadvantages compared with lithium-ion batteries in that they have a larger amount of self-discharging and are more likely to deteriorate due to a phenomenon called sulfation. There is an advantage that the second power storage device 1311 can be maintenance-free when a lithium-ion battery is used; however, in the case of long-term use, for example three years or longer, anomaly that is difficult to determine at the time of manufacturing might occur. In particular, if the second power storage device 1311 that starts the inverter becomes inoperative, there is a risk that the motor cannot be started even with the capacity remaining in the first power storage devices 1301a and 1301b have; thus, in order to prevent this, in the case where the second power storage device 1311 is a lead storage battery, the second battery is supplied with electric power from the first battery to constantly maintain a fully-charged state.

In this embodiment, an example in which a lithium-ion battery is used as both the first power storage device 1301a and the second power storage device 1311 is described. As the second power storage device 1311, a lead storage battery, an all-solid-state battery, or an electric double layer capacitor may be used. For example, the all-solid-state battery may be used. The use of the all-solid-state battery as the second power storage device 1311 can achieve high capacity and reduction in size and weight.

Regenerative energy generated by rolling of tires 1316 is transmitted to the motor 1304 through a gear 1305, and is stored in the second power storage device 1311 from a motor controller 1303 and a battery controller 1302 through a control circuit portion 1321. Alternatively, the regenerative energy is stored in the first power storage device 1301a from the battery controller 1302 through the control circuit portion 1320. Alternatively, the regenerative energy is stored in the first power storage device 1301b from the battery controller 1302 through the control circuit portion 1320. For efficient charging with regenerative energy, the first power storage devices 1301a and 1301b are desirably capable of fast charging.

The battery controller 1302 can set the charge voltage, charge current, and the like of the first power storage devices 1301a and 1301b. The battery controller 1302 can set charge conditions in accordance with charge performance of a secondary battery used, so that fast charging can be performed.

Although not illustrated, in the case of connecting to an external charger, a plug of the charger or a connection cable of the charger is electrically connected to the battery controller 1302. Electric power supplied from the external charger is stored in the first power storage devices 1301a and 1301b through the battery controller 1302. Some chargers are provided with a control circuit, in which case the function of the battery controller 1302 is not used; to prevent overcharging, the first power storage devices 1301a and 1301b are preferably charged through the control circuit portion 1320. In addition, the plug of the charger or the connection cable of the charger is sometimes provided with a control circuit. The control circuit portion 1320 is also referred to as an ECU (Electronic Control Unit). The ECU is connected to a CAN (Controller Area Network) provided in an electric motor vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet-a 200 V outlet, or a three-phase 200 V outlet with 50 kW, for example. Furthermore, charging can be performed with electric power supplied from external charging equipment by a contactless power feeding method or the like.

For fast charging, secondary batteries that can withstand high-voltage charging are desired to perform charging in a short time.

Moreover, in the case where graphene is used as a conductive material, a loading amount can be increased by forming a thick electrode layer, a reduction in capacity can be suppressed, and a high capacity can be maintained. In other words, a secondary battery having greatly improved electrical characteristics can be provided. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Next, examples in which the secondary battery of one embodiment of the present invention is mounted in a vehicle, typically a transport vehicle, will be described.

Mounting the secondary battery illustrated in any of FIG. 10D, FIG. 12C, and FIG. 16A in vehicles enables next-generation clean energy vehicles such as hybrid vehicles (HVs), electric vehicles (EVs), and plug-in hybrid vehicles (PHVs). The secondary battery can also be mounted in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

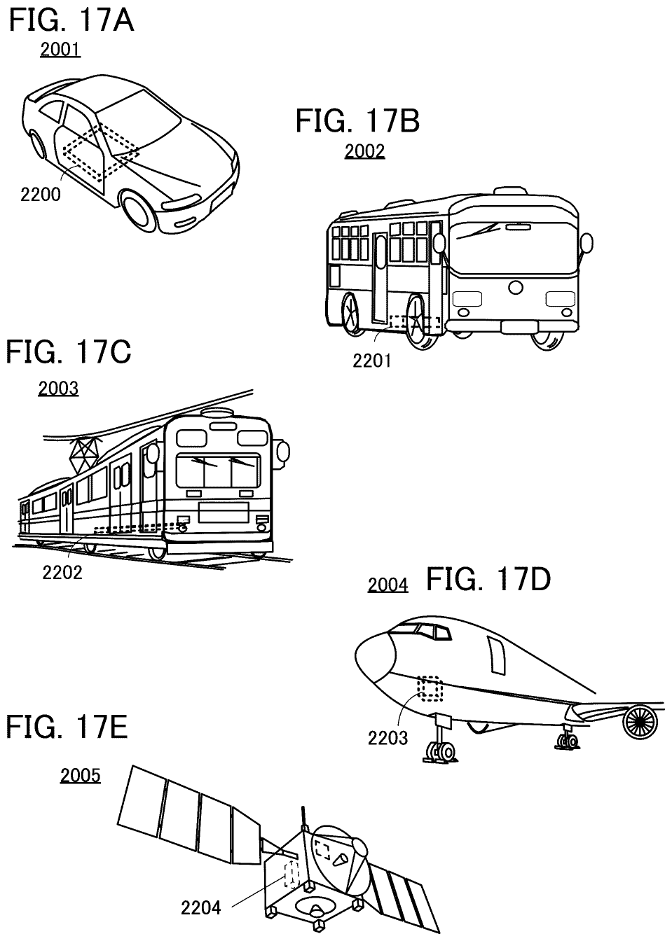

FIG. 17A to FIG. 17D illustrate examples of transport vehicles using one embodiment of the present invention. An automobile 2001 illustrated in FIG. 17A is an electric vehicle that runs using an electric motor as a driving power source. Alternatively, the automobile 2001 is a hybrid vehicle that enables appropriate selection of an electric motor or an engine as a driving power source. In the case where the secondary battery is mounted in the vehicle, the secondary battery described as an example in Embodiment 3 is provided at one position or several positions. The automobile 2001 illustrated in FIG. 17A includes a battery pack 2200, and the battery pack includes a power storage module in which a plurality of secondary batteries are connected to each other. Moreover, the battery pack preferably includes a charge control device that is electrically connected to the power storage module.

The automobile 2001 can be charged when the secondary battery included in the automobile 2001 is supplied with electric power from external charging equipment by a plug-in system, a contactless charge system, or the like. In charging, a given method such as CHAdeMO (registered trademark) or Combined Charging System may be employed as a charge method, the standard of a connector, or the like as appropriate. Charging equipment may be a charge station installed in a commerce facility or a household power supply. For example, with the use of a plug-in technique, the power storage device mounted in the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. In the case of the contactless power feeding system, by installing a power transmitting device in a road or an exterior wall, charging can be performed not only when the vehicle is stopped but also when moving. In addition, the contactless power feeding system may be utilized to perform transmission and reception of electric power between two vehicles. Furthermore, a solar cell may be provided on the exterior of the vehicle to charge the secondary battery while the vehicle is stopped or is moving. To supply electric power in such a contactless manner, an electromagnetic induction method or a magnetic resonance method can be used.

FIG. 17B illustrates a large transporter 2002 having a motor controlled by electricity, as an example of a transport vehicle. In a power storage module of the transporter 2002, four secondary batteries each having a nominal voltage of 3.0 V or higher and 5.0 V or lower are used as a cell unit, and 48 cells are connected in series to have a maximum voltage of 170 V, for example. A battery pack 2201 has the same function as that in FIG. 17A except, for example, the number of secondary batteries configuring the power storage module; thus, the description is omitted.

FIG. 17C illustrates an example of a large transport vehicle 2003 having a motor controlled by electricity. In a power storage module 2202 of the transport vehicle 2003, 100 or more secondary batteries each having a nominal voltage of 3.0 V or higher and 5.0 V or lower are connected in series to have a maximum voltage of 600 V, for example. Thus, the secondary batteries are required to have a small variation in the characteristics.

FIG. 17D illustrates an example of an aircraft 2004 having a combustion engine. The aircraft 2004 illustrated in FIG. 17D can also be regarded as a kind of transport vehicle because it has wheels for takeoff and landing, and includes a battery pack 2203 that includes a charge control device and a power storage module configured by connecting a plurality of secondary batteries.

The power storage module of the aircraft 2004 has eight 4 V secondary batteries connected in series, which has a maximum voltage of 32 V, for example. The battery pack 2203 has the same function as that in FIG. 17A except, for example, the number of secondary batteries configuring the power storage module; thus, the description is omitted.

FIG. 17E illustrates an example of an artificial satellite 2005 including a secondary battery 2204. Because the artificial satellite 2005 is used in an ultra-low-temperature cosmic space, the secondary battery 2204 having excellent low-temperature resistance of one embodiment of the present invention is preferably provided. It is further preferable that the secondary battery 2204 be mounted inside the artificial satellite 2005 while being covered with a heat-retaining member.

The structure, method, and the like described in this embodiment can be used in an appropriate combination with any of the structures, methods, and the like described in the other embodiments.

### Embodiment 5

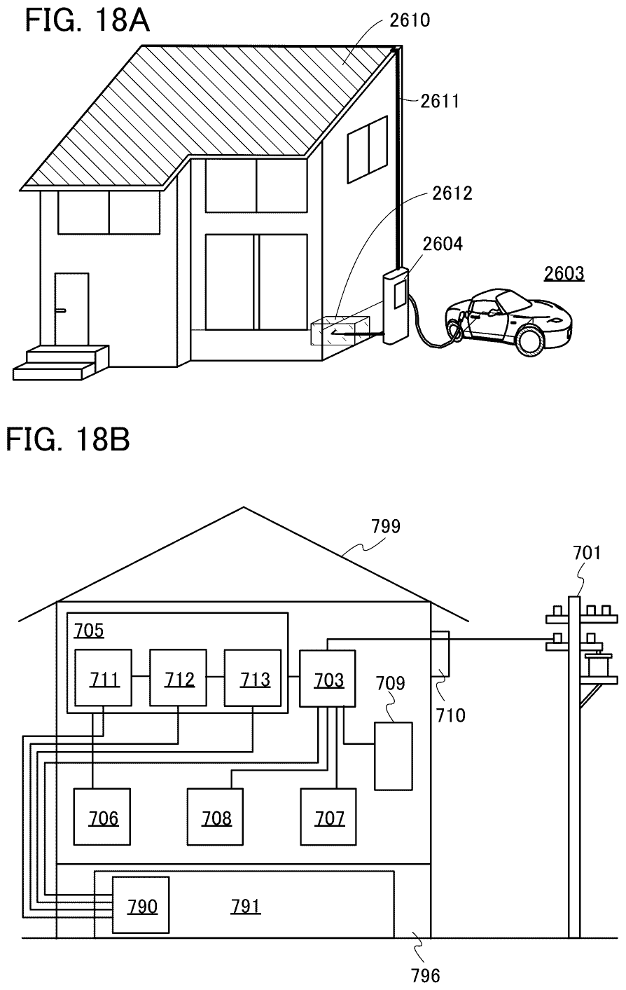

In this embodiment, examples in which the secondary battery of one embodiment of the present invention is mounted in a building will be described with reference to FIG. 18A and FIG. 18B. The structure of the power storage device 1000 or the like described in Embodiment 1 can be used for the secondary battery and the control circuit described in this embodiment.

A house illustrated in FIG. 18A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charge apparatus 2604. The power storage device 2612 can be charged with electric power generated by the solar panel 2610. A secondary battery included in a vehicle 2603 can be charged with the electric power stored in the power storage device 2612 through the charge apparatus 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with use of the power storage device 2612 of one embodiment of the present invention as an uninterruptible power source, electronic devices can be used even when electric power cannot be supplied from a commercial power source due to power failure or the like.

FIG. 18B illustrates an example of a power storage device of one embodiment of the present invention. As illustrated in FIG. 18B, a power storage device 791 of one embodiment of the present invention is installed in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a lead-in wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power to be consumed by the general load 707 and the power storage load 708 during the following day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can also be checked with an electric device such as a TV or a personal computer through the router 709. Furthermore, it can be checked with a portable electronic terminal such as a smartphone or a tablet through the router 709. With the indicator 706, the electric device, or the portable electronic terminal, the demand for electric power in every time period (or per hour) that is predicted by the predicting portion 712 can be checked.

The structure, method, and the like described in this embodiment can be used in an appropriate combination with any of structures, methods, and the like described in the other embodiments.

### Embodiment 6

This embodiment describes examples in which the lithium-ion battery of one embodiment of the present invention is mounted in a two-wheeled vehicle and a bicycle as examples of mounting a secondary battery in a vehicle. The structure of the power storage device 1000 or the like described in Embodiment 1 can be used for the secondary battery and the control circuit described in this embodiment.

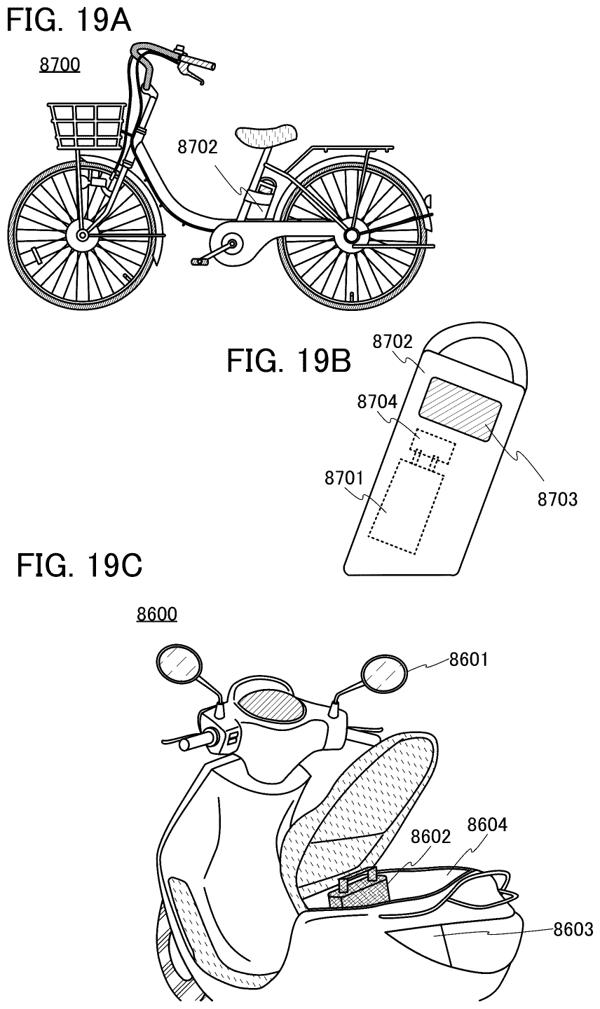

FIG. 19A illustrates an example of an electric bicycle using the power storage device of one embodiment of the present invention. The power storage device of one embodiment of the present invention can be used in an electric bicycle 8700 illustrated in FIG. 19A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 19B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly sensing for the secondary battery, which is exemplified in Embodiment 6. The control circuit 8704 is electrically connected to a positive electrode and a negative electrode of the storage battery 8701.

FIG. 19C illustrates an example of a two-wheeled vehicle including the power storage device of one embodiment of the present invention. A motor scooter 8600 illustrated in FIG. 19C includes a power storage device 8602, side mirrors 8601, and indicator lights 8603. The power storage device 8602 can supply electricity to the indicator lights 8603.

In the motor scooter 8600 illustrated in FIG. 19C, the power storage device 8602 can be stored in an under-seat storage unit 8604. The power storage device 8602 can be stored in the under-seat storage unit 8604 even when the under-seat storage unit 8604 is small.

The structure, method, and the like described in this embodiment can be used in an appropriate combination with any of the structures, methods, and the like described in the other embodiments.

### Embodiment 7

In this embodiment, examples of electronic devices each including the secondary battery of one embodiment of the present invention will be described. Examples of electronic devices including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone. The structure of the power storage device 1000 or the like described in Embodiment 1 can be used for the secondary battery and the control circuit described in this embodiment.

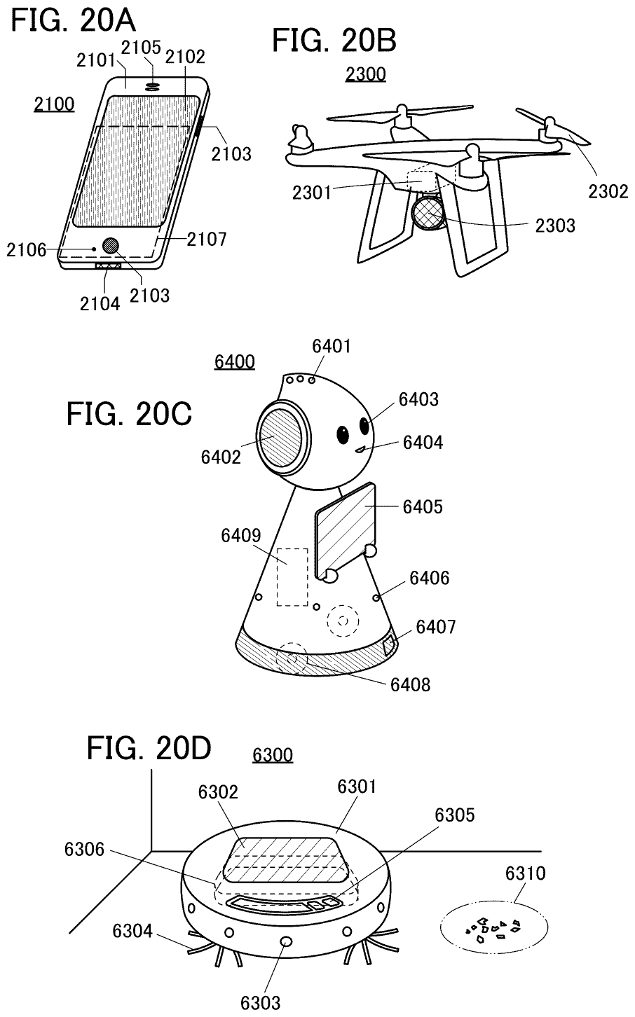

FIG. 20A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a body temperature sensor; a touch sensor; a pressure sensitive sensor; or an acceleration sensor is preferably mounted, for example.

FIG. 20B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna.

FIG. 20C illustrates an example of a robot. A robot 6400 illustrated in FIG. 20C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of sensing a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can sense the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component.

FIG. 20D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, senses dust 6310, and sucks up the dust through the inlet provided on a bottom surface.

The cleaning robot 6300 can determine whether there is an obstacle such as a wall, furniture, or a step by analyzing images taken by the cameras 6303. In the case where the cleaning robot 6300 senses an object, such as a wire, that is likely to be caught in the brush 6304 by image analysis, the rotation of the brush 6304 can be stopped. The cleaning robot 6300 includes, in its inner region, the secondary battery 6306 according to one embodiment of the present invention and a semiconductor device or an electronic component.

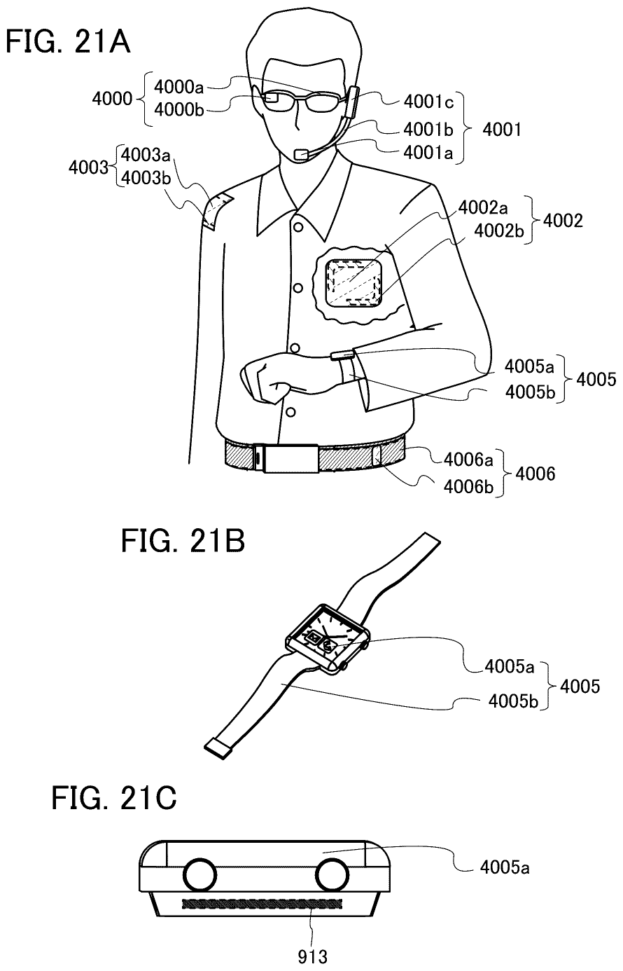

FIG. 21A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be mounted in a glasses-type device 4000 illustrated in FIG. 21A. The glasses-type device 4000 includes a frame 4000a and a display portion 4000b. The secondary battery is mounted in a temple portion of the frame 4000a having a curved shape, whereby the glasses-type device 4000 can be lightweight, can have a well-balanced weight, and can be used continuously for a long time.

The secondary battery of one embodiment of the present invention can be mounted in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c.

The secondary battery of one embodiment of the present invention can be mounted in a device 4002 that can be attached directly to a body. A secondary battery 4002b can be provided in a thin housing 4002a of the device 4002.

The secondary battery of one embodiment of the present invention can be mounted in a device 4003 that can be attached to clothes. A secondary battery 4003b can be provided in a thin housing 4003a of the device 4003.

The secondary battery of one embodiment of the present invention can be mounted in a belt-type device 4006. The belt-type device 4006 includes a belt portion 4006a and a wireless power feeding and receiving portion 4006b, and the secondary battery can be mounted in the inner region of the belt portion 4006a.

The secondary battery of one embodiment of the present invention can be mounted in a watch-type device 4005. The watch-type device 4005 includes a display portion 4005a and a belt portion 4005b, and the secondary battery can be provided in the display portion 4005a or the belt portion 4005b.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be mounted therein. Data on the exercise quantity and health of the user can be stored to be used for health maintenance.

FIG. 21B illustrates a perspective view of the watch-type device 4005 that is detached from an arm.

FIG. 21C illustrates a side view. FIG. 21C illustrates a state where a secondary battery 913 is incorporated in the inner region. The secondary battery 913 is the secondary battery described in Embodiment 3. The secondary battery 913 is provided at a position overlapping with the display portion 4005a, can have high density and high capacity, and is small and lightweight.

The structure, method, and the like described in this embodiment can be used in an appropriate combination with any of structures, methods, and the like described in the other embodiments.

### Reference Numerals

10: battery, 15: control circuit, 34: current sensing element, 36: FET, 37: FET, 41: resistor, 51: external terminal, 52: external terminal, 200A: terminal, 200B: terminal, 200C: terminal, 200D:

terminal, 202A: transistor, 202B: transistor, 203A: diode, 203B: diode, 204A: terminal, 204B: terminal, 205A: terminal, 205B: terminal, 206A: terminal, 206B: terminal, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 513: secondary battery, 514: terminal, 515: sealant, 517: antenna, 519: layer, 529:

label, 531: secondary battery pack, 540: circuit board, 552: other, 590a: circuit system, 590b: circuit system, 590: control circuit, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614A: conductive plate, 614B: conductive plate, 614: conductive plate, 615: power storage module, 616: secondary battery, 620: control circuit, 621: wiring, 622: wiring, 623: wiring, 624: conductor, 625: conductor, 626: wiring, 627: wiring, 628A: conductive plate, 628B: conductive plate, 628: conductive plate, 629: external terminal, 630: external terminal, 701: commercial power source, 703: distribution board, 705: power storage controller, 706: indicator, 707: general load, 708: power storage load, 709: router, 710: lead-in wire mounting portion, 711: measuring portion, 712: predicting portion, 713: planning portion, 790: control device, 791: power storage device, 796: underfloor space, 799: building, 911a: terminal, 911b: terminal, 913: secondary battery, 930a: housing, 930b: housing, 930: housing, 931a: negative electrode active material layer, 931: negative electrode, 932a: positive electrode active material layer, 932: positive electrode, 933: separator, 950a: wound body, 950: wound body, 951: terminal, 952: terminal, 1000: power storage device, 1300: rectangular secondary battery, 1301a: first power storage device, 1301b: first power storage device, 1302: battery controller, 1303: motor controller, 1304: motor, 1305: gear, 1306: DCDC converter, 1307: electric power steering, 1308: heater, 1309: defogger, 1310: DCDC circuit, 1311: second power storage device, 1312: inverter, 1313: stereo, 1314: power window, 1315: lamps, 1316: tire, 1317: rear motor, 1320: control circuit portion, 1321: control circuit portion, 1322: control circuit, 1324: switch portion, 1325: external connection terminal, 1326: external connection terminal, 1332: PTC element, 1413: fixing portion, 1414: fixing portion, 1415: power storage module, 1421: wiring, 1422: wiring, 2001: automobile, 2002: transporter, 2003: transport vehicle, 2004: aircraft, 2005: artificial satellite, 2100: mobile phone, 2101: housing, 2102: display portion, 2103: operation button, 2104: external connection port, 2105: speaker, 2106: microphone, 2107: secondary battery, 2200: battery pack, 2201: battery pack, 2203: battery pack, 2204: secondary battery, 2300: unmanned aircraft, 2301: secondary battery, 2302: rotor, 2303: camera, 2603: vehicle, 2604: charge apparatus, 2610: solar panel, 2611: wiring, 2612: power storage device, 4000a: frame, 4000b: display portion, 4000: glasses-type device, 4001a: microphone portion, 4001b: flexible pipe, 4001c: earphone portion, 4001: headset-type device, 4002a: housing, 4002b: secondary battery, 4002: device, 4003a: housing, 4003b: secondary battery, 4003: device, 4005a: display portion, 4005b: belt portion, 4005: watch-type device, 4006a: belt portion, 4006b: wireless power feeding and receiving portion, 4006: belt-type device, 6300: cleaning robot, 6301: housing, 6302: display portion, 6303: camera, 6304: brush, 6305: operation button, 6306: secondary battery, 6310: dust, 6400: robot, 6401: illuminance sensor, 6402:

microphone, 6403: upper camera, 6404: speaker, 6405: display portion, 6406: lower camera, 6407: obstacle sensor, 6408: moving mechanism, 6409: secondary battery, 8600: motor scooter, 8601: side mirror, 8602: power storage device, 8603: indicator light, 8604: under-seat storage unit, 8700: electric bicycle, 8701: storage battery, 8702: power storage device, 8703: display portion, 8704: control circuit

1. A method for charging a battery comprising a positive electrode active material represented by LiₓMO₂ in a positive electrode,
wherein M is one or more selected from Co, Ni, Mn and Al,
wherein whether first charging is necessary or not is determined by a value of x at a time when charging of the battery starts,
wherein in a case where the first charging is determined to be necessary, the first charging, followed by second charging and then third charging are performed in this order,
wherein in a case where the first charging is determined to be unnecessary, the second charging and then the third charging are performed in this order,
wherein the first charging is charging of longer than or equal to 10 seconds and shorter than or equal to 30 seconds at a current higher than or equal to 1 C and lower than or equal to 5 C,
wherein the second charging is constant current charging, and
wherein the third charging is constant voltage charging.

2. The method for charging a battery according to claim 1, wherein in a case where the value of x is greater than or equal to 0.80 and less than or equal to 1.0, the first charging is determined to be necessary.

3. The method for charging a battery according to claim 1, wherein in a case where the value of x is greater than or equal to 0.40 and less than or equal to 0.60, the first charging is determined to be necessary.

4. The method for charging a battery according to claim 1, wherein in a case where the value of x is greater than or equal to 0.80 and less than or equal to 1.0, or is greater than or equal to 0.40 and less than or equal to 0.60, the first charging is determined to be necessary.

5. The method for charging a battery according to claim 1,
wherein whether first discharging is necessary or not is determined by the value of x at the time when charging of the battery starts,
wherein in a case where the first discharging is determined to be necessary, the first discharging, followed by the second charging and then the third charging are performed in this order,
wherein in a case where the first discharging is determined to be unnecessary, the second charging and the third charging are performed in this order, and
wherein the first discharging is discharging of longer than or equal to 10 seconds and shorter than or equal to 30 seconds at a current higher than or equal to 1 C and lower than or equal to 5 C.

6. The method for charging a battery according to claim 5, wherein in a case where the value of x is greater than or equal to 0.15 and less than or equal to 0.20, the first discharging is determined to be necessary.
